(19) United States
(12) Patent Application Publication
(10) Pub. No.: US 2025/0133561 A1
(43) Pub. Date: Apr. 24, 2025

(54) TECHNIQUES FOR UPLINK CONTROL INFORMATION TRANSMISSION WITH SMALL DATA TRANSMISSION

(71) Applicant: QUALCOMM INCORPORATED, San Diego, CA (US)

(72) Inventors: Jing Lei, San Diego, CA (US); Ruiming Zheng, Beijing (CN); Linhai He, San Diego, CA (US)

(21) Appl. No.: 18/688,287

(22) PCT Filed: Oct. 9, 2021
(86) PCT No.: PCT/CN2021/122764

§ 371 Date: Feb. 29, 2024

(51) Int. Cl. H04W 72/1268; H04W 24/08; H04W 74/0833

(52) U.S. Cl. CPC H04W 72/1268; H04W 24/08; H04W 74/0833

(57) ABSTRACT

Methods, systems, and devices for wireless communications are described. A user equipment (UE) may be configured to receive, from a base station, control signaling identifying a first set of resources for data transmissions and a second set of resources for uplink control information (UCI) transmission by the UE when the UE is in an inactive state or an idle state. The UE may generate, when the UE is in one of the inactive state or the idle state, a UCI message based on the second set of resources. The UE may then transmit, to the base station when the UE in the one of the inactive state or the idle state, a data message on at least a portion of the first set of resources and the UCI message on the second set of resources.

### CROSS REFERENCE

The present application is a 371 national stage filing of International PCT Application No. PCT/CN2021/122764 by Lei et al. entitled “TECHNIQUES FOR UPLINK CONTROL INFORMATION TRANSMISSION WITH SMALL DATA TRANSMISSION,” filed Oct. 9, 2021, which is assigned to the assignee hereof, and which is expressly incorporated by reference in its entirety herein.

### FIELD OF TECHNOLOGY

The present disclosure relates to wireless communications, including techniques for uplink control information (UCI) transmission with small data transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may configure UEs to transmit small data transmissions (SDTs) while in an inactive or idle state. The use of SDTs may enable UEs to communicate small amounts of data to the network without having to establish a full wireless connection with the network (e.g., by entering an active state), which may reduce control signaling overhead. However, the utility of some conventional SDT techniques is limited.

### SUMMARY

The described techniques relate to improved methods, systems, devices, and apparatuses that support techniques for uplink control information (UCI) transmission with small data transmission. Generally, aspects of the present disclosure provide techniques which enable user equipments (UEs) to transmit uplink control information (UCI) messages associated with small data transmissions (SDTs) while in an inactive state (e.g., radio resource control (RRC) inactive state) or idle state (e.g., RRC idle state). In particular, aspects of the present disclosure support various SDT configurations defining different sets of rules or conditions which UEs may use to determine whether they are able to transmit UCI messages along with SDTs while in an inactive or idle state. In some cases, a UE may receive control signaling which indicates sets of resources for communicating SDTs and UCI messages while the UE is in an inactive or idle state. In some cases, the control signaling may configure the UE with separate sets of resources for communicating SDTs and UCI messages, where in other cases the UE may be configured to multiplex UCI messages along with SDTs using the same set of resources. In the context of random access SDT (RA-SDT) configurations, the control signaling may include a message of a random access procedure which configures the UE with a set of resources for random access messages which may be used to transmit SDT and/or UCI messages. Comparatively, in the context of configured grant SDT (CG-SDT) configurations, a UE may receive a message (e.g., an radio resource control (RRC) release message) which releases the UE from an active state to an inactive or idle state, where the message configures the UE with sets of resources (e.g., physical uplink control channel (PUCCH) resources, physical uplink shared channel (PUSCH) resources) for SDT and UCI messages.

A method is described. The method may include receiving, from a base station, control signaling identifying a first set of resources for data transmissions and a second set of resources for UCI transmission by the UE when the UE is in an inactive state or an idle state, generating, when the UE is in one of the inactive state or the idle state, a UCI message based on the second set of resources, and transmitting, to the base station when the UE in the one of the inactive state or the idle state, a data message on at least a portion of the first set of resources and the UCI message on the second set of resources.

An apparatus is described. The apparatus may include a processor, memory coupled with the processor, and instructions stored in the memory. The instructions may be executable by the processor to cause the apparatus to receive, from a base station, control signaling identifying a first set of resources for data transmissions and a second set of resources for UCI transmission by the UE when the UE is in an inactive state or an idle state, generate, when the UE is in one of the inactive state or the idle state, a UCI message based on the second set of resources, and transmit, to the base station when the UE in the one of the inactive state or the idle state, a data message on at least a portion of the first set of resources and the UCI message on the second set of resources.

Another apparatus is described. The apparatus may include means for receiving, from a base station, control signaling identifying a first set of resources for data transmissions and a second set of resources for UCI transmission by the UE when the UE is in an inactive state or an idle state, means for generating, when the UE is in one of the inactive state or the idle state, a UCI message based on the second set of resources, and means for transmitting, to the base station when the UE in the one of the inactive state or the idle state, a data message on at least a portion of the first set of resources and the UCI message on the second set of resources.

A non-transitory computer-readable medium storing code is described. The code may include instructions executable by a processor to receive, from a base station, control signaling identifying a first set of resources for data transmissions and a second set of resources for UCI transmission by the UE when the UE is in an inactive state or an idle state, generate, when the UE is in one of the inactive state or the idle state, a UCI message based on the second set of resources, and transmit, to the base station when the UE in the one of the inactive state or the idle state, a data message on at least a portion of the first set of resources and the UCI message on the second set of resources.

In some examples of the method, apparatuses, and non-transitory computer-readable medium described herein, receiving the control signaling may include operations, features, means, or instructions for receiving, from the base station, a random access message of a random access procedure that identifies the first set of resources and the second set of resources.

In some examples of the method, apparatuses, and non-transitory computer-readable medium described herein, receiving the control signaling may include operations, features, means, or instructions for receiving, from the base station when the UE may be in an active state, a message associated with releasing the UE from the active state to the inactive state or the idle state, where the message identifies the first set of resources and the second set of resources.

In some examples of the method, apparatuses, and non-transitory computer-readable medium described herein, transmitting the UCI message may include operations, features, means, or instructions for transmitting the UCI message on the second set of resources with a random access message of a random access procedure.

In some examples of the method, apparatuses, and non-transitory computer-readable medium described herein, and the method, apparatuses, and non-transitory computer-readable medium may include further operations, features, means, or instructions for transmitting the UCI message with the random access message based on identifying that a timing advance (TA) for the UE may be valid.

In some examples of the method, apparatuses, and non-transitory computer-readable medium described herein, and the method, apparatuses, and non-transitory computer-readable medium may include further operations, features, means, or instructions for transmitting the UCI message with the random access message after identifying that a TA for the UE may be invalid.

Some examples of the method, apparatuses, and non-transitory computer-readable medium described herein may further include operations, features, means, or instructions for receiving the control signaling when the UE may be in an active state, the control signaling indicating a set of multiple transmission occasions for the data transmissions, the set of multiple transmission occasions including the first set of resources, where the data message and the UCI message may be transmitted within a transmission occasion of the set of multiple transmission occasions.

In some examples of the method, apparatuses, and non-transitory computer-readable medium described herein, transmitting the data message and the UCI message may include operations, features, means, or instructions for multiplexing the data message and the UCI message within the transmission occasion.

In some examples of the method, apparatuses, and non-transitory computer-readable medium described herein, transmitting the data message and the UCI message may include operations, features, means, or instructions for refraining from transmitting the data message within a first transmission occasion of the set of multiple transmission occasions based on generating the UCI message to be transmitted in the first transmission occasion, transmitting the UCI message within the first transmission occasion based on refraining from transmitting the data message, and transmitting the data message within a second transmission occasion of the set of multiple transmission occasions based on transmitting the UCI message within the first transmission occasion.

Some examples of the method, apparatuses, and non-transitory computer-readable medium described herein may further include operations, features, means, or instructions for receiving, via the control signaling, an indication for the UE to multiplex the UCI with the data message within the second set of resources which may be included within the first set of resources, where transmitting the data message and the UCI message may be based on the indication.

In some examples of the method, apparatuses, and non-transitory computer-readable medium described herein, the second set of resources include a set of common uplink control resources, a set of dedicated uplink control resources, or any combination thereof and the first set of resources include a set of uplink shared resources.

Some examples of the method, apparatuses, and non-transitory computer-readable medium described herein may further include operations, features, means, or instructions for transmitting the UCI message based on identifying that a TA for the UE may be valid.

In some examples of the method, apparatuses, and non-transitory computer-readable medium described herein, identifying that the TA for the UE may be valid may include operations, features, means, or instructions for identifying that a first TA for the UCI message may be valid, that a second TA for the data message may be valid, that a third TA for both the UCI message and the data message may be valid, or any combination thereof.

Some examples of the method, apparatuses, and non-transitory computer-readable medium described herein may further include operations, features, means, or instructions for receiving, via the control signaling, an indication of a suspension of TA validation at the UE, where transmitting the UCI message may be at least in part in response to the suspension of TA validation.

In some examples of the method, apparatuses, and non-transitory computer-readable medium described herein, the UCI message includes hybrid automatic repeat request (HARQ) feedback responsive to a contention resolution message, a downlink control plane message, a downlink user plane message, an RRC release message, or any combination thereof.

In some examples of the method, apparatuses, and non-transitory computer-readable medium described herein, the UCI message includes a first channel state information (CSI) report that may be smaller than a second CSI report for an active state, a beam failure report, a bandwidth part (BWP) index, a coverage enhancement request, a request for a termination of a set of data messages including the data message, or any combination thereof.

Some examples of the method, apparatuses, and non-transitory computer-readable medium described herein may further include operations, features, means, or instructions for receiving, from the base station, a control message indicating one or more parameters associated with the UCI message, the one or more parameters including a resource index, a transmit beam index, a quantity of repetitions, a frequency hopping scheme, an orthogonal cover code (OCC), or any combination thereof, where the control message includes a downlink control information message, a medium access control-control element message, an RRC message, a system information message, or any combination thereof.

A method for wireless communication at a base station is described. The method may include transmitting, to a UE, control signaling identifying a first set of resources for data transmissions and a second set of resources for UCI transmission by the UE when the UE is in an inactive state or an idle state and receiving, from the UE when the UE in the one of the inactive state or the idle state, a data message on at least a portion of the first set of resources and a UCI message on the second set of resources.

An apparatus for wireless communication at a base station is described. The apparatus may include a processor, memory coupled with the processor, and instructions stored in the memory. The instructions may be executable by the processor to cause the apparatus to transmit, to a UE, control signaling identifying a first set of resources for data transmissions and a second set of resources for UCI transmission by the UE when the UE is in an inactive state or an idle state and receive, from the UE when the UE in the one of the inactive state or the idle state, a data message on at least a portion of the first set of resources and a UCI message on the second set of resources.

Another apparatus for wireless communication at a base station is described. The apparatus may include means for transmitting, to a UE, control signaling identifying a first set of resources for data transmissions and a second set of resources for UCI transmission by the UE when the UE is in an inactive state or an idle state and means for receiving, from the UE when the UE in the one of the inactive state or the idle state, a data message on at least a portion of the first set of resources and a UCI message on the second set of resources.

A non-transitory computer-readable medium storing code for wireless communication at a base station is described. The code may include instructions executable by a processor to transmit, to a UE, control signaling identifying a first set of resources for data transmissions and a second set of resources for UCI transmission by the UE when the UE is in an inactive state or an idle state and receive, from the UE when the UE in the one of the inactive state or the idle state, a data message on at least a portion of the first set of resources and a UCI message on the second set of resources.

In some examples of the method, apparatuses, and non-transitory computer-readable medium described herein, transmitting the control signaling may include operations, features, means, or instructions for transmitting a random access message of a random access procedure that identifies the first set of resources and the second set of resources.

In some examples of the method, apparatuses, and non-transitory computer-readable medium described herein, transmitting the control signaling may include operations, features, means, or instructions for transmitting, to the UE when the UE may be in an active state, a message associated with releasing the UE from the active state to the inactive state or the idle state, where the message identifies the first set of resources and the second set of resources.

In some examples of the method, apparatuses, and non-transitory computer-readable medium described herein, receiving the UCI message may include operations, features, means, or instructions for receiving the UCI message on the second set of resources with a random access message of a random access procedure.

Some examples of the method, apparatuses, and non-transitory computer-readable medium described herein may further include operations, features, means, or instructions for transmitting, via the control signaling, an indication for the UE to multiplex the UCI with the data message within the second set of resources which may be included within the first set of resources, where receiving the data message and the UCI message may be at least in part in response to transmitting the indication.

In some examples of the method, apparatuses, and non-transitory computer-readable medium described herein, the second set of resources include a set of common uplink control resources, a set of dedicated uplink control resources, or any combination thereof and the first set of resources include a set of uplink shared resources.

Some examples of the method, apparatuses, and non-transitory computer-readable medium described herein may further include operations, features, means, or instructions for transmitting, via the control signaling, an indication of a suspension of TA validation at the UE, where receiving the UCI message may be at least in part in response to the suspension of TA validation.

In some examples of the method, apparatuses, and non-transitory computer-readable medium described herein, the UCI message includes HARQ feedback responsive to a contention resolution message, a downlink control plane message, a downlink user plane message, an RRC release message, or any combination thereof.

In some examples of the method, apparatuses, and non-transitory computer-readable medium described herein, the UCI message includes a first CSI report that may be smaller than a second CSI report for an active state, a beam failure report, a BWP index, a coverage enhancement request, a request for a termination of a set of data messages including the data message, or any combination thereof.

Some examples of the method, apparatuses, and non-transitory computer-readable medium described herein may further include operations, features, means, or instructions for transmitting, to the UE, a control message indicating one or more parameters associated with the UCI message, the one or more parameters including a resource index, a transmit beam index, a quantity of repetitions, a frequency hopping scheme, an OCC, or any combination thereof, where the control message includes a downlink control information message, a medium access control-control element message, an RRC message, a system information message, or any combination thereof.

### BRIEF DESCRIPTION OF THE DRAWINGS

FIG. 1 illustrates an example of a wireless communications system that supports techniques for uplink control information (UCI) transmission with small data transmission in accordance with aspects of the present disclosure.

FIG. 2 illustrates an example of a wireless communications system that supports techniques for UCI transmission with small data transmission in accordance with aspects of the present disclosure.

FIG. 3 illustrates an example of a resource configuration that supports techniques for UCI transmission with small data transmission in accordance with aspects of the present disclosure.

FIG. 4 illustrates an example of a process flow that supports techniques for UCI transmission with small data transmission in accordance with aspects of the present disclosure.

FIG. 5 illustrates an example of a process flow that supports techniques for UCI transmission with small data transmission in accordance with aspects of the present disclosure.

FIG. 6 illustrates an example of a process flow that supports techniques for UCI transmission with small data transmission in accordance with aspects of the present disclosure.

FIGS. 7 and 8 show block diagrams of devices that support techniques for UCI transmission with small data transmission in accordance with aspects of the present disclosure.

FIG. 9 shows a block diagram of a communications manager that supports techniques for UCI transmission with small data transmission in accordance with aspects of the present disclosure.

FIG. 10 shows a diagram of a system including a device that supports techniques for UCI transmission with small data transmission in accordance with aspects of the present disclosure.

FIGS. 11 and 12 show block diagrams of devices that support techniques for UCI transmission with small data transmission in accordance with aspects of the present disclosure.

FIG. 13 shows a block diagram of a communications manager that supports techniques for UCI transmission with small data transmission in accordance with aspects of the present disclosure.

FIG. 14 shows a diagram of a system including a device that supports techniques for UCI transmission with small data transmission in accordance with aspects of the present disclosure.

FIGS. 15 through 19 show flowcharts illustrating methods that support techniques for UCI transmission with small data transmission in accordance with aspects of the present disclosure.

### DETAILED DESCRIPTION

Some wireless communications systems may configure user equipments (UEs) to transmit small data transmissions (SDTs) while in an inactive or idle state. The use of SDTs may enable UEs to communicate small amounts of data to the network without having to establish a full wireless connection with the network (e.g., by entering an active state), which may reduce control signaling overhead. Some systems may support one or both of two different types of SDT configurations: (1) random access SDT (RA-SDT), and (2) configured grant SDT (CG-SDT). In RA-SDT, UEs may be able to transmit SDTs along with random access messages communicated during a random access procedure with the network while the UE is in the inactive or idle state. Comparatively, in CG-SDT, the network may configure UEs with sets of transmission occasions which may be used to communicate SDTs while the UE is in the inactive or idle state.

In some cases, a UE may have control information (e.g., data for an uplink control information (UCI) message) which needs to be sent to the network. However, conventional wireless communications systems only enable UCI messages to be communicated while the UE is in an active state. As such, according to some conventional techniques, UEs may be required to establish a full wireless connection with the network before it may communicate a UCI message, which may result in increased signaling overhead, power consumption, and UCI latency.

Accordingly, aspects of the present disclosure are directed to techniques which enable UEs to transmit UCI messages associated with SDTs while in an inactive or idle state. In particular, aspects of the present disclosure enable different SDT configurations defining different sets of rules or conditions which UEs may use to determine whether they are able to transmit UCI messages along with SDTs while in an inactive or idle state. For the purposes of the present disclosure, the term “SDT” may refer to a data message with a size that is less than some threshold size. In some cases, the threshold size for SDTs may be pre-configured, configured/signaled by the network, or both.

In some cases, a UE may receive control signaling which indicates sets of resources for communicating SDTs and UCI messages while the UE is in an inactive or idle state. In some cases, the control signaling may configure the UE with separate sets of resources for communicating SDTs and UCI messages, where in other cases the UE may be configured to multiplex UCI messages along with SDTs using the same set of resources.

In the context of RA-SDT, the control signaling may include a message of a random access procedure which configures the UE with a set of resources for random access messages which may be used to transmit SDT and/or UCI messages. Comparatively, in the context of CG-SDT, a UE may receive a message (e.g., a radio resource control (RRC) release message) which releases the UE from an active state to an inactive or idle state, where the message configures the UE with sets of resources (e.g., physical uplink control channel (PUCCH) resources, physical uplink shared channel (PUSCH) resources) for SDT and UCI messages. UCI messages transmitted by the UE while in an inactive or idle state may include hybrid automatic repeat request (HARQ) feedback information, UE assistance information (e.g., channel state information (CSI) reports, preferred bandwidth parts (BWPs)), and the like. In some cases, the UE may be required to perform timing advance (TA) validation for the SDT and/or UCI message.

As used herein, an active state may refer to an RRC active state or RRC connected stated (e.g., RRC CONNECTED or NR-RRC CONNECTED), for example where the UE operates according to a connected mode. An active state may also refer to other states having the characteristics or performing the operations described herein for an active state. Examples of characteristics or operations performed by a UE operating in an active state (e.g., connected state) include an established connection for one or both a control or user plane between a 5G core (5GC) and base station (e.g., radio access network for 5G (NG-RAN)); the UE access stratum context being stored in the base station (e.g., NG-RAN) and the UE; base station (e.g., NG-RAN) knowing the cell to which the UE belongs; transferring/communicating unicast data to and from the UE; and network controlled mobility including measurements.

As used herein, an inactive state may refer to an RRC inactive state (e.g., RRC INACTIVE or NR-RRC INACTIVE), for example where the UE operates according to a connected mode. An inactive state may also refer to other states having the characteristics or performing the operations described herein for an inactive state. Examples of characteristics or operations performed by a UE operating in an inactive state include broadcasting system information by the base station; cell re-selection mobility; paging is initiated by the base station (e.g., NG-RAN) (RAN paging); RAN-based notification area (RNA) is managed by NG-RAN; DRX for RAN paging configured by NG-RAN; 5GC to NG-RAN connection (one or both of control and user planes) is established for UE; the UE AS context is stored in NG-RAN and the UE; and NG-RAN knows the RNA to which the UE belongs.

As used herein, an idle state may refer to an RRC idle state (e.g., RRC idle or NR-RRC IDLE), for example where the UE operates according to an idle mode. An idle state may also refer to other states having the characteristics or performing the operations described herein for an idle state. Examples of characteristics or operations performed by a UE operating in an idle state include public land mobile network (PLMN; selection; broadcast of system information; cell re-selection mobility; paging for mobile terminated data is initiated by 5GC; paging for mobile terminated data area is managed by 5GC; and discontinuous reception for core network paging configured by non-access stratum.

On power up, a UE may enter an idle (e.g., disconnected) state, where the UE may not yet be registered with the network in some examples. The UE may then perform an attach procedure to enter an active (e.g., and connected) state. The connected state may be suspended, where the UE enters an inactive (e.g., and connected) state. In the active state and inactive state, the UE may still be registered with and connected to the network. The UE may be resumed and return to the active state from the inactive state. However, if the connection with the network (e.g., to the base station) fails, the UE may return to the idle state from the inactive state. Similarly, while the UE is in the active state, the UE may return to the idle state if the UE detaches, or if the connection with the network (e.g., to the base station) fails.

The UE may also operate in idle mode DRX, or connected mode DRX. In idle mode DRX, while in an idle state, the UE periodically wakes up to monitor for paging messages and goes back to sleep mode if paging message is not intended for the UE according to a DRX cycle. In connected mode DRX, while in a connected state, the UE may transition between DRX active state and DRX sleep state according to a DRX cycle (e.g., either long cycle type, or short cycle type), monitoring for physical downlink control channel (PDCCH) during the DRX active state.

Aspects of the disclosure are initially described in the context of wireless communications systems. Aspects of the disclosure are further described in the context of an example resource configuration and example process flows. Aspects of the disclosure are further illustrated by and described with reference to apparatus diagrams, system diagrams, and flowcharts that relate to techniques for UCI transmission with small data transmission.

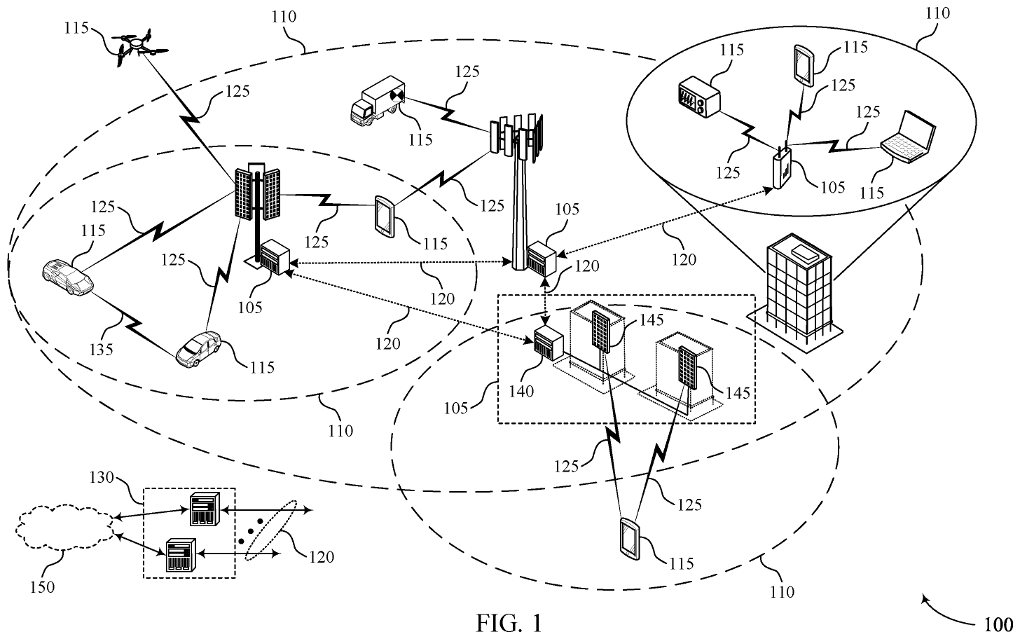

FIG. 1 illustrates an example of a wireless communications system 100 that supports techniques for UCI transmission with small data transmission in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier. In some aspects, the terms “inactive state,” “idle state,” and like terms, may additionally or alternatively be used to describe a “low power mode,” and vice versa.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some aspects, the UEs 115 and the base stations 105 of the wireless communications system 100 may support techniques which enable UEs 115 to transmit UCI messages associated with SDTs while in an inactive or idle state. In particular, the wireless communications system 100 may support various SDT configurations defining different sets of rules or conditions which UEs 115 may use to determine whether they are able to transmit UCI messages along with SDTs while in an inactive or idle state. In some cases, a UE 115 of the wireless communications system 100 may receive control signaling from the network (e.g., base station 105) which indicates sets of resources for communicating SDTs and UCI messages while the UE 115 is in an inactive or idle state. In some cases, the control signaling may configure the UE 115 with separate sets of resources for communicating SDTs and UCI messages, where in other cases the UE 115 may be configured to multiplex UCI messages along with SDTs using the same set of resources.

In the context of RA-SDT, the control signaling received from the network of the wireless communications system 100 may include a message of a random access procedure which configures the UE with a set of resources for random access messages which may be used to transmit SDT and/or UCI messages. Comparatively, in the context of CG-SDT, a UE 115 may receive a message (e.g., RRC release message) which releases the UE 115 from an active state to an inactive or idle state, where the message configures the UE 115 with sets of resources (e.g., PUCCH resources, PUSCH resources) for SDT and UCI messages. UCI messages transmitted by the UE 115 while in an inactive or idle state may include HARQ feedback information, UE assistance information (e.g., CSI reports, preferred BWPs, beam failure reports), and the like. In some cases, the UE may be required to perform TA validation for the SDT and/or UCI message.

Techniques described herein may facilitate more efficient use of resources by enabling UEs 115 to transmit UCI messages along with SDTs while in an inactive state and/or idle state. In particular, by enabling UEs 115 to transmit UCI messages along with SDTs in an inactive or idle state, techniques described herein may prevent the need for UEs 115 to establish full wireless connections with the network in order to transmit small amounts of control data. As such, techniques described herein may reduce signaling overhead associated with establishing wireless connections between UEs 115 and the network, and may reduce latency associated with UCI messages.

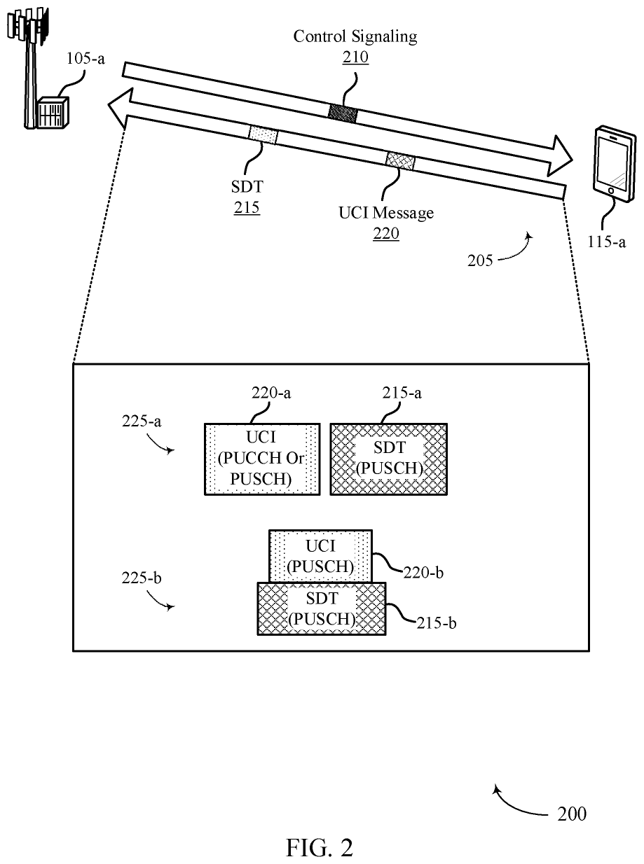

FIG. 2 illustrates an example of a wireless communications system 200 that supports techniques for UCI transmission with small data transmission in accordance with aspects of the present disclosure. In some examples, wireless communications system 200 may implement, or be implemented by, aspects of wireless communications system 100. Wireless communications system 200 may support techniques for transmitting UCI messages along with SDTs in cases where a UE 115 is in an inactive state and/or idle state, as described in FIG. 1.

The wireless communications system 200 may include a UE 115-a and a base station 105-a, which may be examples of UEs 115, base stations 105, and other wireless devices as described with reference to FIG. 1. In some aspects, the UE 115-a may communicate with the base station 105-a using a communication link 205, which may be an example of an NR or LTE link between a base station 105-a and the UE 115-a. In some aspects, the communication link 205 between the base station 105-a and the UE 115-a may include an example of an access link (e.g., Uu link) which may include a bi-directional link that enables both uplink and downlink communication.

In some aspects, the wireless communications system 200 may enable UEs 115 (e.g., UE 115-a) to transmit SDTs while in an inactive or idle state. The use of SDTs may enable UEs 115 to communicate small amounts of data to the network without having to establish a full wireless connection with the network (e.g., by entering an active state), which may reduce control signaling overhead. In particular, the wireless communications system 200 may support one or both of two different types of SDT configurations: (1) RA-SDT configurations, and (2) CG-SDT configurations.

In RA-SDT, UEs may be able to transmit SDTs along with random access messages communicated during a random access procedure with the network while the UE is in the inactive or idle state. In particular, RA-SDT configurations may enable the transmission of small uplink data transmissions (e.g., SDTs) for random access channel (RACH) based schemes, including two-step RACH procedures and four-step RACH procedures. In general, RA-SDT procedures enable UEs 115 to transmit uplink data transmission for small data packets while in an inactive state (e.g., RRC inactive state) by multiplexing the SDTs with messages of a RACH procedure (e.g., via MsgA and/or Msg3 of a RACH procedure). Different wireless communications systems may support flexible payload sizes for SDTs in the context of RA-SDT configurations. Moreover, RA-SDT configurations may enable context fetch and data forwarding (with and without anchor relocation) for UEs 115 in the inactive state for RACH-based solutions

Comparatively, in CG-SDT configurations, the network (e.g., base station 105-a) may configure the UE 115-a with sets of transmission occasions which may be used to communicate SDTs while the UE 115-a is in the inactive state and/or idle state (e.g., RRC inactive or idle state). CG-SDT configurations may enable transmission of small amounts of uplink data on pre-configured PUSCH and/or PUCCH resources (e.g., reusing the configured grant type 1) when TA at the UE 115-a is valid. In general, CG-SDT configurations enable small data transmission over configured grant type 1 resources while the UE 115-a is in an inactive state.

In some cases, the UE 115-a may have control information which must be sent to the network, for example, via a UCI message. In particular, the UE 115-a may have control information to be sent to the network via a UCI message while the UE 115-a is in an inactive or idle state. For example, UCI messages transmitted while in an inactive or idle state may include HARQ ACK/NACK information responsive to a downlink control/user plane message (e.g., RRCRelease message), UE assistance information (e.g., CSI reports) to enable resource optimization, interference management, and power savings, turbo HARQ for CG-SDT, and the like. However, conventional wireless communications systems only enable UCI messages to be communicated while the UE 115-a is in an active state. As such, according to some conventional SDT techniques, the UE 115-a may be required to establish a full wireless connection with the network (e.g., enter an active state) before it may communicate a UCI message, which may result in increased signaling overhead, power consumption, and UCI latency.

Accordingly, the wireless communications system 200 may support techniques which enable the UE 115-a to transmit UCI messages 220 associated with SDTs 215 while in an inactive or idle state. In particular, the wireless communications system 200 may support multiple SDT configurations 225 which each define different sets of rules or conditions which the UE 115-a may use to determine whether it is able to transmit UCI messages 220 along with SDTs 215 while in an inactive or idle state, including whether UCI messages 220 are to be multiplexed with SDTs 215, transmitted separately, or both. Such techniques may facilitate more efficient use of resources within the wireless communications system 200 by enabling the UE 115-a to transmit UCI messages 220 along with SDTs 215 while in an inactive state and/or idle state which may reduce signaling overhead associated with establishing wireless connections between the UE 115-a and the network, and may reduce latency associated with UCI messages 220.

For example, as shown in FIG. 2, the UE 115-a may receive control signaling 210 from the base station 105-a, where the control signaling 210 identifies one or more sets of resources for data transmissions (e.g., SDTs 215) and UCI messages 220 when the UE 115-a is in an inactive state (e.g., RRC inactive state) and/or idle state (e.g., RRC idle state). For example, the control signaling 210 may indicate a first set of resources and a second set of resources which may be used to transmit SDTs 215 and UCI messages 220, respectively, while the UE 115-a is in an inactive or idle state. In this example, the first set of resources for SDT 215 may include uplink shared resources (e.g., PUSCH resources), where the second set of resources for UCI transmission may include uplink shared resources (e.g., PUSCH resources) and/or uplink control resources (e.g., PUCCH resources).

In some implementations, and in the context of RA-SDT, the control signaling 210 may include a random access message of a random access procedure (e.g., two-step RACH procedure, four-step RACH procedure). In such cases, the control signaling 210 may include system information, an RRC reconfiguration message, or both. For example, the control signaling 210 may include system information for an RA-SDT configuration for communicating SDTs 215 in the context of a RACH procedure. Comparatively, in the context of CG-SDT, the control signaling 210 may include an RRC release message which releases the UE 115-a from an active state to the inactive or idle state.

In some aspects, the control signaling 210 may indicate an SDT configuration 225 (e.g., RA-SDT, CG-SDT) which defines a set of rules or conditions which may be used to determine if (and when) UCI messages 220 may be transmitted along with SDTs 215 while the UE 115-a is in an inactive or idle state. For example, the control signaling 210 may indicate whether or not the network supports transmission of UCI messages 220 while the UE 115-a is in the inactive or idle state, sets of resources for transmitting SDTs 215 and/or UCI messages 220, and the like. By way of another example, the control signaling 210 may indicate an SDT configuration 225 which indicates whether UCI messages 220 are to be transmitted separately from SDTs 215 (e.g., first SDT configuration 225-a), whether UCI messages 220 are to be multiplexed with SDTs 215 (e.g., second SDT configuration 225-b), whether UCI messages 220 must satisfy TA validation, and the like.

The set of resources configured via the control signaling 210 and allocated for UCI messages 220 may include PUCCH resources, PUSCH resources, or both. For example, in some cases (e.g., some SDT configurations 225), the control signaling 210 may indicate a set of common PUCCH resources, a set of dedicated PUCCH resources, or both, which may be used for UCI messages 220 when the UE 115-a is in an inactive or idle state. For example, the control signaling 210 may indicate a set of common PUCCH resources corresponding to pucch-ResourceCommon. In the context of common PUCCH resources, the control signaling 210 may indicate PUCCH formats which are dedicated to RA-SDT and/or CG-SDT procedures. Additionally, or alternatively, the control signaling 210 may include one or more bit field values which may be interpreted by the UE 115-a to refer to indicated sets of PUCCH resources.

By way of another example, the control signaling 210 may indicate a set of dedicated PUCCH resources corresponding to PUCCH-Config. For instance, in cases where the UE 115-a is in an RRC inactive state, the UE 115-a may have previously been connected to the network such that the base station 105-a already knows the identity of the UE 115-a. As such, the base station 105-a may configure the UE 115-a (e.g., via the control signaling 210) with a set of dedicated PUCCH resources.

In additional or alternative cases, the control signaling 210 may indicate a set of PUSCH resources which are to be used for UCI transmission when the UE 115-a is in the inactive or idle state. For example, in the context of RA-SDT, the control signaling 210 may indicate that UCI messages 220 are to be multiplexed with random access messages associated with random access procedures (e.g., two-step RACH procedure, four-step RACH procedure) performed between the UE 115-a and the base station 105-a. In other cases, the control signaling 210 may indicate a set of transmission occasions (e.g., CG-SDT PUSCH transmission occasions) for transmitting SDTs 215, UCI messages 220, or both.

In some aspects, the base station 105-a may indicate parameters associated with transmission of the UCI via a control message, where the control message may be the same as the control signaling 210 and/or a separate control message. Parameters associated with the UCI message may include a resource index (e.g., PUCCH resource index), a quantity of repetitions for PUCCH transmission (e.g., quantity of repetitions of UCI), a frequency hopping scheme of PUCCH (e.g., UCI frequency hopping scheme), a transmit beam index (e.g., Tx beam index of PUCCH), an orthogonal code cover (OCC) of PUCCH, or any combination thereof. Parameters associated with UCI transmission may be communicated via any control signaling or control message, including a DCI message, a MAC CE message, an RRC message, a system information message, or any combination thereof.

In some aspects, the UE 115-a, the base station 105-a, or both, may perform TA validation. In other words, the UE 115-a and/or the base station 105-a may determine whether a TA for the UE 115-a is valid or invalid. A TA associated with the UE 115-b may include a timing offset used by the UE 115-a to communicate a message (or type of message) with the base station 105-a (or other device), and may be associated with a propagation delay between the UE 115-a and the base station 105-a. As such, the TA for the UE 115-a may be a function of how far the UE 115-a is from the base station 105-a (e.g., larger TA if the UE 115-a is further away from base station 105-a, smaller TA if the UE 115-a is closer to the base station 105-a). The TA(s) for the UE 115-a may be determined/controlled by the base station 105-b through TA commands. Moreover, the TA for the UE 115-a may be valid only for a defined period of time, where the validity of the TA is controlled by a TA timer. In some aspects, the control signaling 210 may include a TA command, an indication of a TA timer, or both. In other cases, TA commands and/or TA timers may be communicated via other signaling from the base station 105-a.

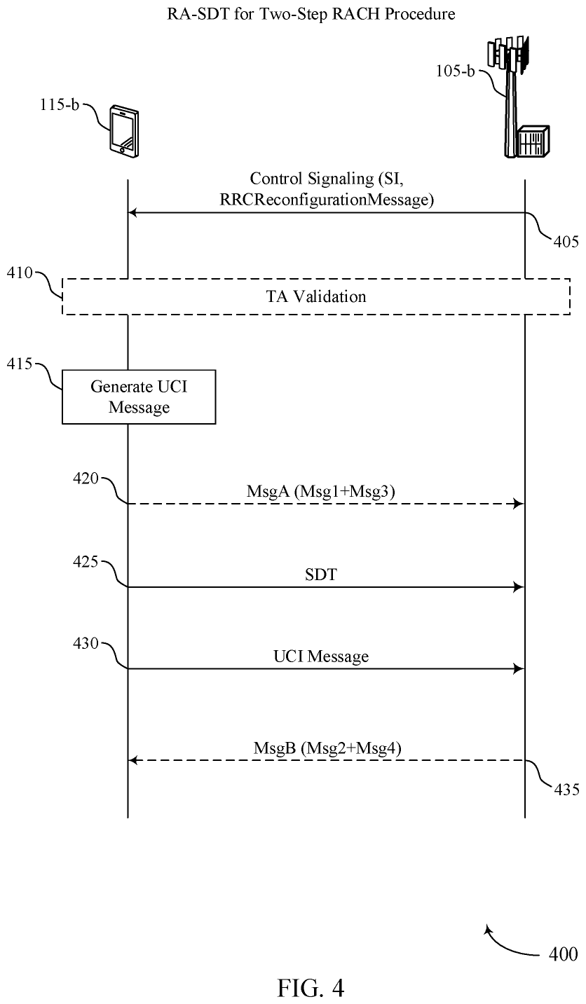

In some aspects, the UE 115-a and/or the base station 105-a may perform the TA validation at based on transmitting/receiving the control signaling 210. For example, in some aspects, the UE 115-a may perform TA validation based on a TA command and/or TA timer received via the control signaling 210, a random access message of a RACH procedure, or both. In some aspects, TA validation procedures may vary based on the type of SDT configuration 225. For example, different rules or conditions may be used for performing TA validation in the context of RA-SDT for two-step RACH procedures, RA-SDT for four-step RACH procedures, and for CG-SDT procedures. Various rules/conditions for performing TA validation will be discussed in further detail with respect to FIGS. 4-6.

In some aspects, the UE 115-a may generate the UCI message 220. In particular, the UE 115-a may generate the UCI message 220 while the UE 115-a is in the inactive or idle state, and upon determining that the UE 115-a has data (e.g., control data) which is to be transmitted to the base station 105-a. The UE 115-a may generate the UCI message 220 based on receiving the control signaling 210, performing the TA validation, or both. For example, the UE 115-a may generate the UCI message 220 based on determining that a TA for the UE 115-a is valid.

The UE 115-a may transmit a data message (e.g., SDT 215) to the base station 105-a. The UE 115-a may transmit the SDT 215 while in the inactive or idle state. The UE 115-a may transmit the SDT 215 based on receiving the control signaling 210, performing the TA validation, generating the UCI message 220, or any combination thereof. In particular, the UE 115-a may transmit the SDT 215 on at least a portion of the first set of resources for data transmissions which were allocated via the control signaling 210. Moreover, in cases where the control signaling 210 indicates that data messages are to be included with (e.g., multiplexed with) random access messages, the UE 115-a may transmit the SDT 215 along with a random access message (e.g., MsgA, Msg3) of a random access procedure performed with the base station 105-a. For example, in some implementations, the UE 115-a may multiplex the SDT 215 with a random access message (e.g., MsgA, Msg3) of a two-step and/or four-step RACH procedure.

In some aspects, the UE 115-a may transmit the UCI message 220 to the base station 105-a. The UE 115-a may transmit the UCI message 220 while in the inactive or idle state. Moreover, the UE 115-a may transmit the UCI message 220 within an uplink BWP configured for RA-SDT and/or CG-SDT (e.g., BWP for RA-SDT and/or CG-SDT indicated via the control signaling 210). The UE 115-a may transmit the UCI message 220 based on receiving the control signaling 210, performing the TA validation, generating the UCI message 220, transmitting the SDT 215, or any combination thereof. In particular, the UE 115-a may transmit the UCI message 220 on at least a portion of the second set of resources for UCI transmission which were allocated via the control signaling 210.

Moreover, in cases where the control signaling 210 indicates that UCI messages 220 are to be included with (e.g., multiplexed with) random access messages, the UE 115-a may transmit the UCI message 220 along with a random access message of a random access procedure. For example, in some implementations, the UE 115-a may multiplex the UCI message 220 with MsgA and/or Msg3 of a RACH procedure performed with the base station 105-a.

In some aspects, the UE 115-a may transmit the UCI message 220 separately from the SDT 215. For example, as shown in the first SDT configuration 225-a, the UE 115-a may transmit the UCI message 220-a prior to the SDT 215-a. In such cases, the SDT 215-a may be transmitted via PUSCH resources, where the UCI message 220-a may be transmitted via PUCCH resources and/or PUSCH resources. Additionally, or alternatively, the UCI message 220 may be multiplexed with the SDT 215. For example, as shown in the second SDT configuration 225-b, the UE 115-b may multiplex the UCI message 220-b with the SDT 215-b such that both the UCI message 220-b and the SDT 215-b are transmitted via PUSCH resources.

The UE 115-a may transmit the UCI message 220 and/or the SDT 215 based on the TA validation procedure. The various rules/conditions for performing TA validation will be described in further detail with respect to FIGS. 4-6.

The UCI message 220 may include any uplink data, including HARQ feedback information, UE-assistance information, and the like. For example, the UCI message 220 may include HARQ feedback information responsive to a contention resolution message (e.g., contention resolution message of contention-based SDT 215), HARQ feedback information responsive to a downlink control plane message and/or downlink user plane message, HARQ feedback information responsive to an RRC release message (e.g., RRCRelease message used to reconfigure or release SDT 215 resources for RA-SDT or CG-SDT), or any combination thereof. By way of another example, the UCI message 220 may include a CSI report, a BWP index (e.g., index of preferred BWP), a beam failure report, a coverage enhancement request (e.g., request for coverage enhancement of SDT 215), a request for a termination of a set of data messages (e.g., request for early termination of SDT 215), UE-assistance information multiplexed with HARQ feedback (e.g., CSI report multiplexed with HARQ feedback and mapped to UCI), or any combination thereof. For instance, the UCI message 220 may include a compact CSI report which may help the network improve and optimize the spectral efficiency of SDT 215 communications. In such cases, the compact CSI report may be aperiodic, semi-static, or both, and may be smaller than a CSI report transmitted by the UE 115-b when the UE 115-b is in an active state.

Techniques described herein may facilitate more efficient use of resources by enabling the UE 115-a to transmit UCI messages 220 along with SDTs 215 while in an inactive state and/or idle state. In particular, by enabling the UE 115-a to transmit UCI messages 220 along with SDTs 215 in an inactive or idle state, techniques described herein may enable the UE 115-a to transmit small amounts of control data prior to (or without) establishing a full wireless connection with the base station 105-a, which may reduce signaling overhead associated with establishing wireless connections between the UE 115-a and the network, and may reduce latency associated with UCI messages 220.

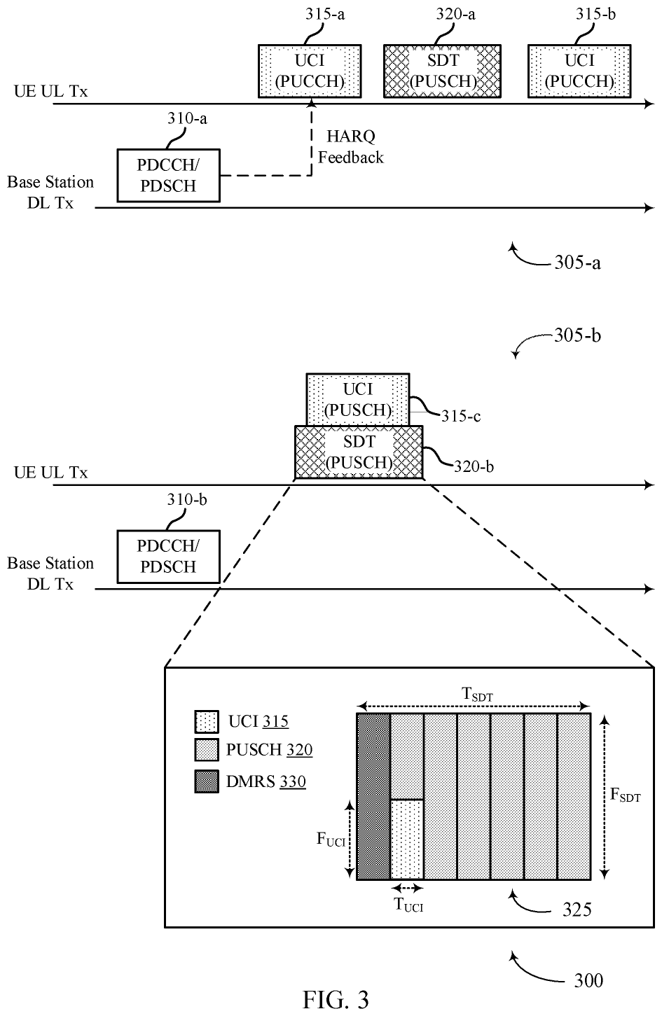

FIG. 3 illustrates an example of a resource configuration 300 that supports techniques for UCI transmission with small data transmission in accordance with aspects of the present disclosure. In some examples, the resource configuration 300 may implement, or be implemented by, aspects of wireless communications system 100, wireless communications system 200, or both.

The resource configuration 300 illustrates different SDT configurations 305 for transmitting UCI messages along with SDTs. In particular, a first SDT configuration 305 illustrates a UE 115 transmitting UCI messages 315 before and/or after an SDT 320, whereas a second SDT configuration 305-b illustrates a UCI message 315 multiplexed with an SDT 320.

As shown in the first SDT configuration 305-a, a UE 115 may receive a downlink message 310-a from a base station 105. The downlink message 310-a may include a PDCCH message, a physical downlink shared channel (PDSCH) message, or both. For example, the downlink message 310-a may include a downlink message in which the UE 115 is to provide HARQ feedback, such as an RRC reconfiguration message, a downlink user plane message, a downlink control plane message, or any combination thereof. In some cases, the UE 115 may receive the downlink message 310-a while in an inactive or idle state, and may therefore have uplink data (e.g., HARQ feedback information) which is to be transmitted via a UCI message 315 in response to the downlink message 310-a.

Continuing with reference to the first SDT configuration 305-a, the UE 115 may receive control signaling which allocates sets of resources for SDTs 320 and UCI messages 315 while the UE 115 is in an inactive or idle state. As such, the UE 115 may be configured to transmit UCI messages 315 including HARQ feedback (and/or UE assistance information) in response to the downlink message 310-a while the UE 115 is in the inactive or idle state. As described previously herein, the UE 115 may be configured with PUSCH resources for SDT transmission, and may be configured with PUCCH and/or PUSCH resources for UCI messages. For example, as shown in FIG. 2, the UE 115 may transmit a first UCI message 315-a and a second UCI message 315-b via PUCCH resources, and may transmit an SDT 320-a via PUSCH resources. In this example, the UE 115 may transmit the first UCI message 315-a prior to the SDT 320-a in the time domain, and may transmit the second UCI message 315-b subsequent to the SDT 320-a in the time domain.

In additional or alternative implementations, the UE 115 may be configured to multiplex UCI messages 315 with SDTs 320 while in the inactive or idle state. For example, referring now to the second SDT configuration 305-b, the UE may receive a downlink message 310-b from a base station 105. The downlink message 310-b may include a PDCCH message, a PDSCH message, or both. For example, the downlink message 310-b may include a downlink message in which the UE 115 is to provide HARQ feedback, such as an RRC reconfiguration message, a downlink user plane message, a downlink control plane message, or any combination thereof. In some cases, the UE 115 may receive the downlink message 310-b while in an inactive or idle state, and may therefore have uplink data (e.g., HARQ feedback information) which is to be transmitted via a UCI message 315 in response to the downlink message 310-b.

In this example, the UE 115 may multiplex a UCI message 315-c (e.g., UCI message 315-c including HARQ feedback and/or UE assistance information) with an SDT 320-b while in the inactive or idle state. In this regard, the UE 115 may be configured to multiplex the UCI message 315-c via a set of PUSCH resources 325 configured for SDT transmission. For example, as shown in FIG. 3, the UE 115 may receive control signaling which indicates a set of PUSCH resources 325 spanning a set of time resources (TSDT) in the time domain and a set of frequency resources (FSDT) in the frequency domain. In such cases, the control signaling may additionally indicate a subset of the set of PUSCH resources 325 which are to be used for multiplexing UCI messages 315. In this regard, the set of PUSCH resources 325 may include a first set of resources allocated for SDT transmission, and a second set of resources allocated for UCI transmission (e.g., resources spanning T_{UCI} in the time domain and F_{UCI} in the frequency domain). In some cases, the set of PUSCH resources may additionally include a set of resources for demodulation reference signals (DMRSs) 330.

FIG. 4 illustrates an example of a process flow 400 that supports techniques for UCI transmission with small data transmission in accordance with aspects of the present disclosure. In some examples, process flow 400 may implement, or be implemented by, aspects of wireless communications system 100, wireless communications system 200, resource configuration 300, or any combination thereof. For example, the process flow 400 illustrates a UE 115-b transmitting a UCI message in the context of a two-step RACH procedure (e.g., two-step RA-SDT), as described with reference to FIGS. 1-3.

In some cases, process flow 400 may include a UE 115-b and a base station 105-b, which may be examples of corresponding devices as described herein. For example, the UE 115-b and the base station 105-b illustrated in FIG. 4 may include examples of the UE 115-a and the base station 105-a, respectively, as illustrated in FIG. 2.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-b may receive control signaling from the base station 105-b, where the control signaling identifies one or more sets of resources for data transmissions (e.g., SDTs) and UCI messages when the UE 115-b is in an inactive state (e.g., RRC inactive state) and/or idle state (e.g., RRC idle state). For example, the control signaling may indicate a first set of resources and a second set of resources which may be used to transmit SDTs and UCI messages, respectively, while the UE 115-b is in an inactive or idle state. In this example, the first set of resources for SDT may include uplink shared resources (e.g., PUSCH resources), where the second set of resources for UCI transmission may include uplink shared resources (e.g., PUSCH resources) and/or uplink control resources (e.g., PUCCH resources). In some implementations, the control signaling may include a random access message of a random access procedure (e.g., two-step RACH procedure). The control signaling may include system information, an RRC reconfiguration message, or both. For example, the control signaling may include system information for an RA-SDT configuration for communicating SDTs in the context of a RACH procedure.

In some aspects, the control signaling may indicate an SDT configuration (e.g., RA-SDT) which defines a set of rules or conditions which may be used to determine if (and when) UCI messages may be transmitted along with SDTs while the UE 115-b is in an inactive or idle state. For example, the control signaling may indicate whether or not the network supports transmission of UCI messages while the UE 115-b is in the inactive or idle state, sets of resources for transmitting SDTs and/or UCI messages, and the like. By way of another example, the control signaling may indicate an SDT configuration which indicates whether UCI messages are to be transmitted separately from SDTs, whether UCI messages are to be multiplexed with SDTs, whether UCI messages must satisfy TA validation, and the like. In the context of a two-step RACH procedure shown in FIG. 4, frequency hopping and/or coverage enhancement for UCI/SDT transmissions may be enabled and disabled by the network (e.g., base station 105-b). Moreover, in the context of RA-SDT configurations, the control signaling may indicate whether UCI messages and/or SDTs are to be transmitted in association with random access messages of a RACH procedure, multiplexed with random access messages of a RACH procedure, or both.

The set of resources configured via the control signaling and allocated for UCI messages may include PUCCH resources, PUSCH resources, or both. For example, in some cases (e.g., some SDT configurations), the control signaling may indicate a set of common PUCCH resources, a set of dedicated PUCCH resources, or both, which may be used for UCI messages when the UE 115-b is in an inactive or idle state. For example, the control signaling may indicate a set of common PUCCH resources corresponding to pucch-ResourceCommon. In the context of common PUCCH resources, the control signaling may indicate PUCCH formats which are dedicated to RA-SDT procedures. Additionally, or alternatively, the control signaling (e.g., RRCReconfigurationMessage) may include one or more bit field values which may be interpreted by the UE 115-b to refer to indicated sets of PUCCH resources.

By way of another example, the control signaling may indicate a set of dedicated PUCCH resources corresponding to PUCCH-Config. For instance, in cases where the UE 115-b is in an RRC inactive state, the UE 115-b may have previously been connected to the network such that the base station 105-b already knows the identity of the UE 115-b. As such, the base station 105-b may configure the UE 115-b (e.g., via the control signaling) with a set of dedicated PUCCH resources.

In additional or alternative cases, the control signaling may indicate a set of PUSCH resources which are to be used for UCI transmission when the UE 115-b is in the inactive or idle state. For example, the control signaling may indicate that UCI messages are to be multiplexed with MsgA PUSCH resources for initial and retransmissions configured for the two-step RA-SDT procedure. In other words, the control signaling may indicate that UCI messages may be multiplexed on PUSCH resources used to communicate MsgA of the two-step RACH procedure. By way of another example, the control signaling may indicate that UCI messages may be multiplexed with Msg3 fallback transmissions configured for the RA-SDT procedure. In such cases, the base station 105-b may detect the preamble portion of MsgA only, and may issue a random access response grant for SDT retransmission. In other words, the control signaling may indicate that UCI messages may be multiplexed on PUSCH resources used to communicate Msg3 of the two-step RACH procedure.

In some aspects, one or more parameters associated with PUCCH (e.g., UCI transmission) may be indicated to the UE 115, where the one or more parameters include a PUCCH resource index, a number of repetitions for PUCCH transmission, a frequency hopping scheme of PUCCH, a transmit beam index of PUCCH, an OCC of PUCCH, or any combination thereof. Such parameters may be signaled to UE 115 via a DCI message, a MAC-CE message, an RRC message, a system information message, or any combination thereof. In such cases, the parameters for UCI transmission (e.g., parameters for PUCCH) may be indicated via the control signaling, via a separate control message, or both.

At 410, the UE 115-b, the base station 105-b, or both, may perform TA validation. In other words, the UE 115-b and/or the base station 105-b may determine whether a TA for the UE 115-b is valid or invalid. In some aspects, the UE 115-b and/or the base station 105-b may perform the TA validation at 410 based on transmitting/receiving the control signaling at 405.

As noted previously herein, a TA associated with the UE 115-b may include a timing offset used by the UE 115-b to communicate with the base station 105-b (or other device), and may be associated with a propagation delay between the UE 115-b and the base station 105-b. As such, the TA for the UE 115-b may be a function of how far the UE 115-b is from the base station 105-b (e.g., larger TA if the UE 115-b is further away from base station 105-b, smaller TA if the UE 115-b is closer to the base station 105-b). The TA for the UE 115-b may be determined/controlled by the base station 105-b through TA commands. Moreover, the TA for the UE 115-b may be valid only for a defined period of time, where the validity of the TA is controlled by a TA timer. In some aspects, the control signaling at 405 may include a TA command, an indication of a TA timer, or both. In other cases, TA commands and/or TA timers may be communicated via other signaling from the base station 105-b.

In the context of an RA-SDT configuration based on a two-step RACH procedure, as shown and described in FIG. 4, TA validation for UCI transmission may or may not be applicable depending on the resources used to transmit the UCI message. For example, when a UCI message is to be multiplexed with MsgA PUSCH or Msg3 fallback, the UE 115-b may be able to transmit the UCI message regardless as to whether the TA timer is valid or not (e.g., TA validation does not apply). In other words, in cases where the UE 115-b is configured to multiplex UCI messages with MsgA or Msg3 of a two-step RACH procedure, the UE 115-b may be configured to transmit the UCI message even in cases where the TA for the UE 115-b is invalid (in addition to cases here the TA is valid). Comparatively, in cases where the UE 115-b is configured to transmit UCI messages on PUCCH resources indicated via the control signaling at 405, the TA timer for the UE 115-b must be valid. That is, in the context of an RA-SDT configuration for two-step RACH procedures, the UE 115-b may be able to transmit UCI messages on PUCCH resources only in cases where the TA for the UE 115-b is valid, and may be unable to transmit UCI messages on PUCCH resources when the TA for the UE 115-b is invalid.

At 415, the UE 115-b may generate the UCI message. In particular, the UE 115-b may generate the UCI message while the UE 115-b is in the inactive or idle state, and upon determining that the UE 115-b has data (e.g., control data) which is to be transmitted to the base station 105-b. The UE 115-b may generate the UCI message at 415 based on receiving the control signaling at 405, performing the TA validation at 410, or both.

For example, the UE 115-b may generate the UCI message at 415 based on determining that a TA for the UE 115-b is valid at 410. By way of another example, the UE 115-b may generate the UCI message at 415 based on determining that TA validation is not required for UCI transmission, such as in cases where the UE 115-b is configured to multiplex UCI messages with MsgA and/or Msg3 of a two-step RACH procedure.

At 420, the UE 115-b may transmit a random access message to the base station 105-b. For example, as shown in FIG. 4, the UE 115-b may transmit MsgA (e.g., Msg1+Msg3) to the base station 105-b as part of a two-step RACH procedure performed between the UE 115-b and the base station 105-b. In such cases, MsgA may include a RACH preamble and data associated with the RACH procedure. The UE 115-b may transmit MsgA of the two-step RACH procedure based on receiving the control signaling at 405, performing TA validation at 410, generating the UCI message at 415, or any combination thereof.

At 425, the UE 115-b may transmit a data message (e.g., SDT) to the base station 105-b. The UE 115-b may transmit the data message at 425 while in the inactive or idle state. The UE 115-b may transmit the data message (SDT) based on receiving the control signaling at 405, performing TA validation at 410, generating the UCI message at 415, transmitting the random access message at 420, or any combination thereof. In particular, the UE 115-b may transmit the SDT at 425 on at least a portion of the first set of resources for data transmissions which were allocated via the control signaling at 405. Moreover, in cases where the control signaling at 405 indicates that data messages are to be included with (e.g., multiplexed with) random access messages, the UE 115-b may transmit the SDT along with the MsgA/Msg3 transmitted at 420. For example, in some implementations, the UE 115-b may multiplex the SDT with the random access message transmitted at 420 (e.g., SDT multiplexed with MsgA/Msg3).

At 430, the UE 115-b may transmit the UCI message to the base station 105-b. The UE 115-b may transmit the UCI message at 430 while in the inactive or idle state. Moreover, the UE 115-b may transmit the UCI message within an uplink BWP configured for RA-SDT (e.g., BWP for RA-SDT indicated via the control signaling at 405). The UE 115-b may transmit the UCI message based on receiving the control signaling at 405, performing TA validation at 410, generating the UCI message at 415, transmitting the random access message at 420, or any combination thereof. In particular, the UE 115-b may transmit the UCI message at 430 on at least a portion of the second set of resources for UCI transmission which were allocated via the control signaling at 405.

Moreover, in cases where the control signaling at 405 indicates that UCI messages are to be included with (e.g., multiplexed with) random access messages, the UE 115-b may transmit the UCI message along with the MsgA/Msg3 transmitted at 420. For example, in some implementations, the UE 115-b may multiplex the UCI message with the random access message transmitted at 420 (e.g., UCI multiplexed with MsgA/Msg3). Further, in some implementations, the UCI message may be multiplexed with the SDT at 425, as shown and described in FIG. 3. For example, the control signaling at 405 may include an indication for the UE 115-b to multiplex the UCI message with the SDT within the second set of resources which are included within the first set of resources allocated for SDT. In this regard, the UE 115-b may transmit the UCI message via a set of PUCCH resources (e.g., common PUCCH resources corresponding to pucch-ResourceCommon, dedicated PUCCH resources corresponding to PUCCH-Config), a set of PUSCH resources (e.g., multiplexed with MsgA/Msg3), or both.

The UE 115-b may transmit the UCI message at 430 based on the TA validation procedure at 410. For example, when the UCI message is to be multiplexed with MsgA PUSCH or Msg3 fallback, the UE 115-b may be able to transmit the UCI message regardless as to whether the TA timer is valid or not (e.g., TA validation does not apply). Comparatively, in cases where the UE 115-b is configured to transmit UCI messages on PUCCH resources indicated via the control signaling at 405, the TA timer for the UE 115-b must be valid. That is, in the context of an RA-SDT configuration for two-step RACH procedures, the UE 115-b may be able to transmit the UCI message on PUCCH resources only in cases where the TA for the UE 115-b is valid.

The UCI message may include any uplink data, including HARQ feedback information, UE-assistance information, and the like. For example, the UCI message may include HARQ feedback information responsive to a contention resolution message (e.g., contention resolution message of contention-based SDT), HARQ feedback information responsive to a downlink control plane message and/or downlink user plane message, HARQ feedback information responsive to an RRC release message (e.g., RRCRelease message used to reconfigure or release SDT resources for RA-SDT or CG-SDT), or any combination thereof. By way of another example, the UCI message may include a CSI report, a BWP index (e.g., index of preferred BWP), a beam failure report, a coverage enhancement request (e.g., request for coverage enhancement of SDT), a request for a termination of a set of data messages (e.g., request for early termination of SDT), UE-assistance information multiplexed with HARQ feedback (e.g., CSI report multiplexed with HARQ feedback and mapped to UCI), or any combination thereof. For instance, the UCI message may include a compact CSI report which may help the network improve and optimize the spectral efficiency of SDT communications. In such cases, the compact CSI report may be aperiodic, semi-static, or both, and may be smaller than a CSI report transmitted by the UE 115-b when the UE 115-b is in an active state.

At 435, the base station 105-b may transmit a second random access message of the two-step RACH procedure. For example, as shown in FIG. 4, the base station 105-b may transmit MsgB (e.g., Msg2+Msg4) to the UE 115-b as part of the two-step RACH procedure performed between the UE 115-b and the base station 105-b.

Techniques described herein may facilitate more efficient use of resources by enabling the UE 115-b to transmit UCI messages along with SDTs while in an inactive state and/or idle state in the context of a two-step RACH procedure. In particular, by enabling the UE 115-b to transmit UCI messages along with SDTs in an inactive or idle state, techniques described herein may enable the UE 115-b to transmit small amounts of control data prior to (or without) establishing a full wireless connection with the base station 105-b, which may reduce signaling overhead associated with establishing wireless connections between the UE 115-b and the network, and may reduce latency associated with UCI messages.

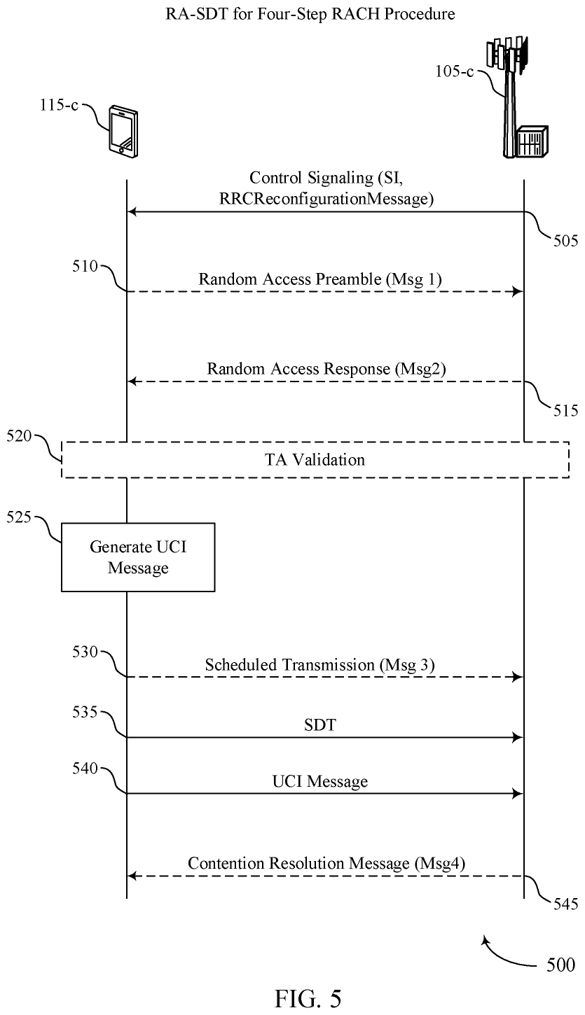

FIG. 5 illustrates an example of a process flow 500 that supports techniques for UCI transmission with small data transmission in accordance with aspects of the present disclosure. In some examples, process flow 400 may implement, or be implemented by, aspects of wireless communications system 100, wireless communications system 200, resource configuration 300, or any combination thereof. For example, the process flow 500 illustrates a UE 115-b transmitting a UCI message in the context of a four-step RACH procedure (e.g., four-step RA-SDT), as described with reference to FIGS. 1-3.

In some cases, process flow 500 may include a UE 115-c and a base station 105-c, which may be examples of corresponding devices as described herein. For example, the UE 115-c and the base station 105-c illustrated in FIG. 5 may include examples of the UE 115-a and the base station 105-a, respectively, as illustrated in FIG. 2.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-c may receive control signaling from the base station 105-c, where the control signaling identifies one or more sets of resources for data transmissions (e.g., SDTs) and UCI messages when the UE 115-c is in an inactive state (e.g., RRC inactive state) and/or idle state (e.g., RRC idle state). For example, the control signaling may indicate a first set of resources and a second set of resources which may be used to transmit SDTs and UCI messages, respectively, while the UE 115-c is in an inactive or idle state. In this example, the first set of resources for SDT may include uplink shared resources (e.g., PUSCH resources), where the second set of resources for UCI transmission may include uplink shared resources (e.g., PUSCH resources) and/or uplink control resources (e.g., PUCCH resources). In some implementations, the control signaling may include a random access message of a random access procedure (e.g., four-step RACH procedure). The control signaling may include system information, an RRC reconfiguration message, or both. For example, the control signaling may include system information for an RA-SDT configuration for communicating SDTs in the context of a RACH procedure.

In some aspects, the control signaling may indicate an SDT configuration (e.g., RA-SDT) which defines a set of rules or conditions which may be used to determine if (and when) UCI messages may be transmitted along with SDTs while the UE 115-c is in an inactive or idle state. For example, the control signaling may indicate whether or not the network supports transmission of UCI messages while the UE 115-c is in the inactive or idle state, sets of resources for transmitting SDTs and/or UCI messages, and the like. By way of another example, the control signaling may indicate an SDT configuration which indicates whether UCI messages are to be transmitted separately from SDTs, whether UCI messages are to be multiplexed with SDTs, whether UCI messages must satisfy TA validation, and the like. In the context of a four-step RACH procedure shown in FIG. 5, frequency hopping and/or coverage enhancement for UCI/SDT transmissions may be enabled and disabled by the network (e.g., base station 105-c). Moreover, in the context of RA-SDT configurations, the control signaling may indicate whether UCI messages and/or SDTs are to be transmitted in association with random access messages of a RACH procedure, multiplexed with random access messages of a RACH procedure, or both.

The set of resources configured via the control signaling and allocated for UCI messages may include PUCCH resources, PUSCH resources, or both. For example, in some cases (e.g., some SDT configurations), the control signaling may indicate a set of common PUCCH resources, a set of dedicated PUCCH resources, or both, which may be used for UCI messages when the UE 115-c is in an inactive or idle state. For example, the control signaling may indicate a set of common PUCCH resources corresponding to pucch-ResourceCommon. In the context of common PUCCH resources, the control signaling may indicate PUCCH formats which are dedicated to RA-SDT procedures. Additionally, or alternatively, the control signaling (e.g., RRCReconfigurationMessage) may include one or more bit field values which may be interpreted by the UE 115-c to refer to indicated sets of PUCCH resources.

By way of another example, the control signaling may indicate a set of dedicated PUCCH resources corresponding to PUCCH-Config. For instance, in cases where the UE 115-c is in an RRC inactive state, the UE 115-c may have previously been connected to the network such that the base station 105-c already knows the identity of the UE 115-c. As such, the base station 105-c may configure the UE 115-c (e.g., via the control signaling) with a set of dedicated PUCCH resources.

In additional or alternative cases, the control signaling may indicate a set of PUSCH resources which are to be used for UCI transmission when the UE 115-c is in the inactive or idle state. For example, the control signaling may indicate that UCI messages are to be multiplexed with Msg3 PUSCH resources for initial and retransmissions configured for the four-step RA-SDT procedure. In other words, the control signaling may indicate that UCI messages may be multiplexed on PUSCH resources used to communicate Msg3 of the four-step RACH procedure.

At 510, the UE 115-c may transmit a random access message (e.g., random access preamble) associated with the four-step RACH procedure between the UE 115-c and the base station 105-c. For example, as shown in FIG. 5, the UE 115-c may transmit Msg1 of the four-step RACH procedure. Msg1 may include a contention-based physical random access channel (PRACH) preamble. In some cases, the UE 115-c may transmit Msg1 at 510 based on receiving the control signaling at 505.

At 515, the UE 115-c may receive a second random access message (e.g., random access response) from the base station 105-c, where the second random access message at 515 is received in response to the first random access message at 510. For example, as shown in FIG. 5, the base station 105-c may transmit Msg2 of the four-step RACH procedure. Msg2 may include information associated with the four-step RACH procedure, including a detected preamble identifier for the preamble which was included within Msg1, a TA command, a temporary cell radio network temporary identifier (C-RNTI), or any combination thereof. Additionally, or alternatively, Msg2 may indicate a set of resources (e.g., uplink grant) which may be used by the UE 115-c for transmitting Msg3 of the four-step RACH procedure.

In some aspects, Msg2 may include a separate control message as compared to the control signaling at 505. In additional or alternative implementations, the control signaling shown and described at 505 may be included with, or may be the same as, the Msg2 shown and described at 515. In this regard, in some cases, Msg2 at 515 may include the control signaling which configures the UE 115-c with sets of resources for transmitting SDTs and UCI messages for RA-SDT while in the inactive or idle state.

At 520, the UE 115-c, the base station 105-c, or both, may perform TA validation. In other words, the UE 115-c and/or the base station 105-c may determine whether a TA for the UE 115-c is valid or invalid. In some aspects, the UE 115-c and/or the base station 105-c may perform the TA validation at 520 based on transmitting/receiving the control signaling at 505, transmitting/receiving Msg1 at 510, transmitting/receiving Msg2 at 515, or any combination thereof. For example, in some aspects, the UE 115-c may perform TA validation based on a TA command and/or TA timer received via Msg2.

In the context of an RA-SDT configuration based on a four-step RACH procedure, as shown and described in FIG. 5, TA validation for UCI transmission may be applicable regardless as to whether the UCI message is transmitted on PUCCH resources or multiplexed with Msg3 of the four-step RACH procedure. For example, when a UCI message is to be multiplexed with Msg3 of the four-step RACH procedure (e.g., PUSCH resources for Msg3), the UE 115-c may be able to transmit the UCI message only when the TA timer for the UE 115-c is valid. Similarly, in cases where the UE 115-c is configured to transmit UCI messages on PUCCH resources indicated via the control signaling at 505 and/or Msg2 at 515, the TA timer for the UE 115-c must be valid. That is, in the context of an RA-SDT configuration for four-step RACH procedures, the UE 115-c may be able to transmit UCI messages on PUCCH resources only in cases where the TA for the UE 115-c is valid, and may be unable to transmit UCI messages on PUCCH resources when the TA for the UE 115-c is invalid.

At 525, the UE 115-c may generate the UCI message. In particular, the UE 115-c may generate the UCI message while the UE 115-c is in the inactive or idle state, and upon determining that the UE 115-c has data (e.g., control data) which is to be transmitted to the base station 105-c. The UE 115-c may generate the UCI message at 525 based on receiving the control signaling at 505, transmitting/receiving Msg1 at 510, transmitting/receiving Msg2 at 515, performing the TA validation at 520, or any combination thereof. For example, the UE 115-c may generate the UCI message at 525 based on determining that a TA for the UE 115-c is valid at 520.

At 530, the UE 115-c may transmit a random access message (e.g., scheduled transmission) to the base station 105-c. For example, as shown in FIG. 5, the UE 115-c may transmit Msg3 to the base station 105-c as part of the four-step RACH procedure performed between the UE 115-c and the base station 105-c. In such cases, Msg3 may include an identifier for contention resolution associated with the RACH procedure. The UE 115-c may transmit Msg3 of the four-step RACH procedure based on receiving the control signaling at 405, transmitting/receiving Msg1 at 510, transmitting/receiving Msg2 at 515, performing the TA validation at 520, generating the UCI message at 525, or any combination thereof.

At 535, the UE 115-c may transmit a data message (e.g., SDT) to the base station 105-c. The UE 115-c may transmit the data message at 535 while in the inactive or idle state. The UE 115-c may transmit the data message (SDT) based on receiving the control signaling at 405, transmitting/receiving Msg1 at 510, transmitting/receiving Msg2 at 515, performing the TA validation at 520, generating the UCI message at 525, transmitting Msg3 at 530, or any combination thereof.

In particular, the UE 115-c may transmit the SDT at 535 on at least a portion of the first set of resources for data transmissions which were allocated via the control signaling at 505 (and/or Msg2 at 515). Moreover, in cases where the control signaling and/or Msg2 indicates that data messages are to be included with (e.g., multiplexed with) random access messages, the UE 115-c may transmit the SDT along with the Msg3 transmitted at 530. For example, in some implementations, the UE 115-c may multiplex the SDT with the random access message transmitted at 530 (e.g., SDT multiplexed with Msg3).

At 540, the UE 115-c may transmit the UCI message to the base station 105-c. The UE 115-c may transmit the UCI message at 540 while in the inactive or idle state. Moreover, the UE 115-c may transmit the UCI message within an uplink BWP configured for RA-SDT (e.g., BWP for RA-SDT indicated via the control signaling at 505 and/or Msg2 at 515). The UE 115-c may transmit the UCI message based on receiving the control signaling at 405, transmitting/receiving Msg1 at 510, transmitting/receiving Msg2 at 515, performing the TA validation at 520, generating the UCI message at 525, transmitting Msg3 at 530, transmitting the SDT at 535, or any combination thereof. In particular, the UE 115-c may transmit the UCI message at 540 on at least a portion of the second set of resources for UCI transmission which were allocated via the control signaling at 505 and/or Msg2 at 515.

Moreover, in cases where the control signaling 505 indicates that UCI messages are to be included with (e.g., multiplexed with) random access messages, the UE 115-c may transmit the UCI message along with Msg3 transmitted at 530. For example, in some implementations, the UE 115-c may multiplex the UCI message with the random access message transmitted at 530 (e.g., UCI multiplexed with Msg3). Further, in some implementations, the UCI message may be multiplexed with the SDT at 535, as shown and described in FIG. 3. For example, the control signaling and/or Msg2 may include an indication for the UE 115-c to multiplex the UCI message with the SDT within the second set of resources which are included within the first set of resources allocated for SDT. In this regard, the UE 115-c may transmit the UCI message via a set of PUCCH resources (e.g., common PUCCH resources corresponding to pucch-ResourceCommon, dedicated PUCCH resources corresponding to PUCCH-Config), a set of PUSCH resources (e.g., multiplexed with Msg3), or both.

The UE 115-c may transmit the UCI message at 540 based on the TA validation procedure at 520. As noted previously herein, in the context of a four-step RACH procedure, TA validation for UCI transmission may be applicable regardless as to whether the UCI message is transmitted on PUCCH resources or multiplexed with Msg3 of the four-step RACH procedure. For example, when a UCI message is to be multiplexed with Msg3 of the four-step RACH procedure (e.g., PUSCH resources for Msg3), the UE 115-c may be able to transmit the UCI message only when the TA timer for the UE 115-c is valid. Similarly, in cases where the UE 115-c is configured to transmit UCI messages on PUCCH resources indicated via the control signaling at 505 and/or Msg2 at 515, the TA timer for the UE 115-c must be valid. That is, in the context of an RA-SDT configuration for four-step RACH procedures, the UE 115-c may be able to transmit UCI messages on PUCCH resources only in cases where the TA for the UE 115-c is valid, and may be unable to transmit UCI messages on PUCCH resources when the TA for the UE 115-c is invalid.

The UCI message may include any uplink data, including HARQ feedback information, UE-assistance information, and the like. For example, the UCI message may include HARQ feedback information responsive to a contention resolution message (e.g., contention resolution message of contention-based SDT), HARQ feedback information responsive to a downlink control plane message and/or downlink user plane message, HARQ feedback information responsive to an RRC release message (e.g., RRCRelease message used to reconfigure or release SDT resources for RA-SDT or CG-SDT), or any combination thereof. By way of another example, the UCI message may include a CSI report, a BWP index (e.g., index of preferred BWP), a beam failure report, a coverage enhancement request (e.g., request for coverage enhancement of SDT), a request for a termination of a set of data messages (e.g., request for early termination of SDT), UE-assistance information multiplexed with HARQ feedback (e.g., CSI report multiplexed with HARQ feedback and mapped to UCI), or any combination thereof. For instance, the UCI message may include a compact CSI report which may help the network improve and optimize the spectral efficiency of SDT communications. In such cases, the compact CSI report may be aperiodic, semi-static, or both, and may be smaller than a CSI report transmitted by the UE 115-b when the UE 115-b is in an active state.

At 545, the base station 105-c may transmit a random access message (e.g., contention resolution message) of the four-step RACH procedure. For example, as shown in FIG. 5, the base station 105-c may transmit Msg4 to the UE 115-c as part of the four-step RACH procedure performed between the UE 115-c and the base station 105-c. In some aspects, Msg4 may include the contention-resolution identifier associated with the RACH procedure performed between the respective wireless devices.

Techniques described herein may facilitate more efficient use of resources by enabling the UE 115-c to transmit UCI messages along with SDTs while in an inactive state and/or idle state in the context of a two-step RACH procedure. In particular, by enabling the UE 115-c to transmit UCI messages along with SDTs in an inactive or idle state, techniques described herein may enable the UE 115-c to transmit small amounts of control data prior to (or without) establishing a full wireless connection with the base station 105-c, which may reduce signaling overhead associated with establishing wireless connections between the UE 115-c and the network, and may reduce latency associated with UCI messages.

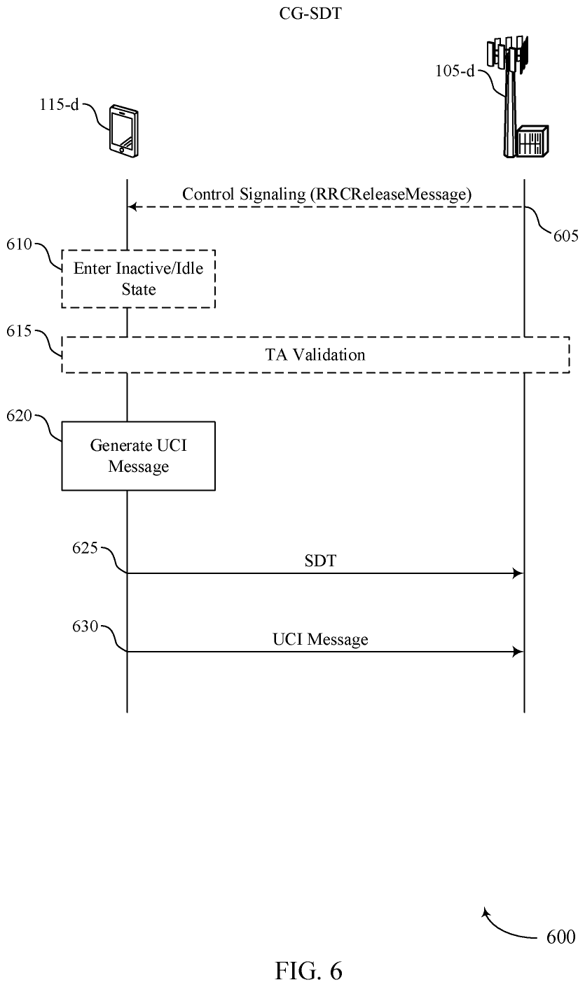

FIG. 6 illustrates an example of a process flow 600 that supports techniques for UCI transmission with small data transmission in accordance with aspects of the present disclosure. In some examples, process flow 600 may implement, or be implemented by, aspects of wireless communications system 100, wireless communications system 200, resource configuration 300, any combination thereof. For example, the process flow 600 illustrates a UE 115-b transmitting a UCI message within resources allocated via configured grant (e.g., CG-SDT), as described with reference to FIGS. 1-3.

In some cases, process flow 600 may include a UE 115-d and a base station 105-d, which may be examples of corresponding devices as described herein. For example, the UE 115-d and the base station 105-d illustrated in FIG. 6 may include examples of the UE 115-a and the base station 105-a, respectively, as illustrated in FIG. 2.

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 605, the UE 115-d may receive control signaling from the base station 105-d, where the control signaling identifies one or more sets of resources for data transmissions (e.g., SDTs) and UCI messages when the UE 115-d is in an inactive state (e.g., RRC inactive state) and/or idle state (e.g., RRC idle state). For example, the control signaling may indicate a first set of resources and a second set of resources which may be used to transmit SDTs and UCI messages, respectively, while the UE 115-d is in an inactive or idle state. In this example, the first set of resources for SDT may include uplink shared resources (e.g., PUSCH resources), where the second set of resources for UCI transmission may include uplink shared resources (e.g., PUSCH resources) and/or uplink control resources (e.g., PUCCH resources).

In some implementations, the control signaling may include an RRC release message which releases the UE 115-d from an active state (e.g., RRC active state) to the inactive state and/or idle state. In such cases, the UE 115-d may receive the control signaling (e.g., RRCReleaseMessage) while the UE 115-d is in an active state (e.g., RRC active state). In some implementations, the BWP used for SDT communications (e.g., BWP used for transmitting/receiving SDTs and/or UCI messages while in the inactive or idle state) may be the same as, or different from, the active BWP where the UE 115-d receives the CG-SDT configuration. In this regard, the UE 115-d may receive the control signaling on an active BWP, where the control signaling indicates sets of resources for SDTs and/or UCI messages on the same BWP, a different BWP, or both.

In some aspects, the control signaling may indicate an SDT configuration (e.g., RA-SDT) which defines a set of rules or conditions which may be used to determine if (and when) UCI messages may be transmitted along with SDTs while the UE 115-d is in an inactive or idle state. For example, the control signaling may indicate whether or not the network supports transmission of UCI messages while the UE 115-d is in the inactive or idle state, sets of resources for transmitting SDTs and/or UCI messages, and the like. By way of another example, the control signaling may indicate an SDT configuration which indicates whether UCI messages are to be transmitted separately from SDTs, whether UCI messages are to be multiplexed with SDTs, whether UCI messages must satisfy TA validation, and the like. In the context of a CG-SDT configuration shown in FIG. 6, frequency hopping and/or coverage enhancement for UCI/SDT transmissions may be enabled and disabled by the network (e.g., base station 105-d). Moreover, in the context of CG-SDT configurations, the control signaling may indicate whether UCI messages and/or SDTs are to be transmitted in separately, multiplexed with one another, or both.

The set of resources configured via the control signaling and allocated for UCI messages may include PUCCH resources, PUSCH resources, or both. For example, in some cases (e.g., some SDT configurations), the control signaling may indicate a set of common PUCCH resources, a set of dedicated PUCCH resources, or both, which may be used for UCI messages when the UE 115-d is in an inactive or idle state. For example, the control signaling may indicate a set of common PUCCH resources corresponding to pucch-ResourceCommon. In the context of common PUCCH resources, the control signaling may indicate PUCCH formats which are dedicated to CG-SDT procedures. Additionally, or alternatively, the control signaling (e.g., RRCReconfigurationMessage) may include one or more bit field values which may be interpreted by the UE 115-d to refer to indicated sets of PUCCH resources. By way of another example, the control signaling may indicate a set of dedicated PUCCH resources corresponding to PUCCH-Config. The PUCCH resource index, number of repetitions for PUCCH transmission, frequency hopping scheme of PUCCH, TX beam index of PUCCH, and orthogonal code cover (OCC) of PUCCH can be signaled to UE by DCI, MAC CE, system information, or a hybrid of the signaling schemes.

In additional or alternative cases, the control signaling may indicate a set of PUSCH resources which are to be used for UCI transmission when the UE 115-d is in the inactive or idle state. In such cases, the control signaling may indicate that UCI messages are to be multiplexed with CG-PUSCH resources configured for the CG-SDT procedure. In other cases, the control signaling may indicate that UCI messages are to be multiplexed with grant-based retransmissions of CG-PUSCH. In some aspects, the control signaling may indicate set(s) of transmission occasions for SDTs and/or UCI messages. For example, the control signaling may include a configured grant which indicates/schedules a set of transmission occasions for transmitting SDTs, UCI messages, or both, while the UE 115-d is in the inactive or idle state. In such cases, the control signaling may indicate that SDTs and UCI messages are to be multiplexed within the same transmission occasions. In other cases, the control signaling may indicate that the UE 115-d is to suspend SDT transmission within a transmission occasion to transmit UCI messages (e.g., suspend CG-PUSCH transmission to transmit UCI/PUCCH on the CG-SDT transmission occasion). In this regard, the first and second sets of resources allocated for SDTs and UCI messages, respectively, may include sets of transmission occasions associated with PUSCH resources.

In some aspects, when UCI messages are to be multiplexed with PUSCH resources of an SDT, the multiplexing scheme/parameters may be indicated in an RRC release message for the CG-SDT (e.g., indicated via the control signaling at 605).

At 610, the UE 115-d may enter the inactive state, the idle state, or both. For example, the UE 115-d may receive the control signaling (e.g., RRCReleaseMessage) at 605 while in the active state, and may subsequently enter or transition to the inactive and/or idle state. For instance, in some cases, the RRC release message may release the UE 115-d from the active state to the inactive or idle state.

At 615, the UE 115-d, the base station 105-d, or both, may perform TA validation. In other words, the UE 115-d and/or the base station 105-d may determine whether a TA for the UE 115-d is valid or invalid. In some aspects, the UE 115-d and/or the base station 105-d may perform the TA validation at 520 based on transmitting/receiving the control signaling at 605, entering the inactive or idle state at 610, or both. For example, in some aspects, the UE 115-d may perform TA validation based on a TA command and/or TA timer received via the control signaling at 605.

In the context of a CG-SDT configuration, as shown and described in FIG. 6, TA validation for UCI transmission may be applicable regardless as to whether the UCI message is transmitted on PUCCH resources or multiplexed with CG-PUSCH resources for SDTs. Moreover, TA validation for UCI in the context of CG-SDT configurations may be based on reference signal received power (RSRP) variation of downlink reference signals, where a set of downlink reference signal beams and RSRP thresholds may be configured by the network (e.g., base station 105-d) for TA validation). The downlink reference signal beams and RSRP thresholds associated with TA validation for UCI may be shared with CG-PUSCH, or separately configured for UCI and SDT. In other words, the control signaling may indicate TA validation parameters (e.g., TA command, TA timer) which are to be used to perform TA validation for both SDTs and UCI messages, or may indicate separate TA validation parameters which are to be used for SDTs and UCI messages, respectively.

In cases where the UE 115-d is to multiplex UCI messages with SDTs (e.g., multiplex UCI with CG-PUSCH), different alternatives/implementations may be used to for performing TA validation. For example, in some implementations, TA validations may be needed for both UCI messages and SDTs (e.g., CG-PUSCHs) in cases where the TA validation parameters are different. In other words, both an SDT and a UCI message may be required to pass separate TA validations in order to be transmitted. In other implementations, if TA validation parameters/configurations are the same for SDTs and UCI messages, the UE 115-d may be configured to transmit both the SDT and UCI message if a TA passes (e.g., valid TA) for the SDT, the UCI, or both. Moreover, in other implementations, TA validation may be required for one of the SDT (e.g., CG-SDT) or UCI message regardless as to whether TA validation parameters/configurations are shared for the SDT and UCI, or separately configured.

Comparatively, in cases where the UE 115-d is to transmit UCI messages on PUCCH resources, different alternatives/implementations may be used to for performing TA validation. For example, in some implementations, the UE 115-d may be required to perform TA validation before each transmission of UCI during SDT. In other words, the UE 115-d may be configured to perform TA validation before each UCI message which is transmitted via PUCCH resources. By way of another example, in some implementations, the UE 115-d and/or the base station 105-d may suspend TA validation such that the UE 115-d is not required to perform TA validation for UCI messages transmitted via PUCCH. For instance, the UE 115-d may suspend TA validation within a time window configured by the network.

At 620, the UE 115-d may generate the UCI message. In particular, the UE 115-d may generate the UCI message while the UE 115-d is in the inactive or idle state, and upon determining that the UE 115-d has data (e.g., control data) which is to be transmitted to the base station 105-d. The UE 115-d may generate the UCI message at 620 based on receiving the control signaling at 605, entering the inactive or idle state at 610, performing the TA validation at 615, or any combination thereof. For example, the UE 115-d may generate the UCI message at 620 based on determining that one or more TAs for the UE 115-d is valid at 615.

At 625, the UE 115-d may transmit a data message (e.g., SDT) to the base station 105-d. The UE 115-d may transmit the data message at 625 while in the inactive or idle state. The UE 115-d may transmit the data message (SDT) based on receiving the control signaling at 605, entering the inactive or idle state at 610, performing the TA validation at 615, generating the UCI message at 620, or any combination thereof.

In particular, the UE 115-d may transmit the SDT at 625 on at least a portion of the first set of resources for data transmissions which were allocated via the control signaling at 605. For example, the UE 115-d may transmit the SDT within a PUSCH transmission occasion (e.g., CG-SDT transmission occasion) for SDTs which was configured via the control signaling at 605.

At 630, the UE 115-d may transmit the UCI message to the base station 105-d. The UE 115-d may transmit the UCI message at 630 while in the inactive or idle state. Moreover, the UE 115-d may transmit the UCI message within an uplink BWP configured for CG-SDT (e.g., BWP for CG-SDT indicated via the control signaling at 605). The UE 115-d may transmit the UCI message based on receiving the control signaling at 405, entering the inactive or idle state at 610, performing the TA validation at 615, generating the UCI message at 620, transmitting the SDT at 625, or any combination thereof.

In particular, the UE 115-d may transmit the UCI message at 630 on at least a portion of the second set of resources for UCI transmission which were allocated via the control signaling at 605. For example, the UE 115-d may transmit the SDT within a PUSCH transmission occasion (e.g., CG-SDT transmission occasion) which was configured via the control signaling at 605. In some cases, the UE 115-d may be configured to multiplex the SDT at 625 and the UCI message at 630 within the same transmission occasion (e.g., PUSCH transmission occasion) which was configured via the control signaling at 605. In other cases, the UE 115-d may transmit the UCI message and the SDT via separate transmission occasions. For instance, in some cases, the UE 115-d may refrain from transmitting the SDT on a first transmission occasion (e.g., suspend SDT) in order to transmit the UCI message on the first transmission occasion. In such cases, the UE 115-d may transmit the suspended SDT in a different (e.g., subsequent) transmission occasion.

In additional or alternative implementations, the UE 115-d may transmit the UCI message via a set of common PUCCH resources (e.g., PUCCH resources corresponding to pucch-ResourceCommon), a set of dedicated PUCCH resources (e.g., PUCCH resources corresponding to PUCCH-Config), or both.

The UE 115-d may transmit the UCI message at 630 based on the TA validation procedure at 615. As noted previously herein, in the context of a CG-SDT procedure, TA validation for UCI transmission may be applicable regardless as to whether the UCI message is transmitted on PUCCH resources or PUSCH resources (e.g., multiplexed with SDT on CG-PUSCH resources). For example, in cases where the UE 115-d is multiplexed with SDT on PUSCH resources, the UE 115-d may transmit the UCI message and SDT based on identifying that a TA for the UCI is valid, a TA for the SDT is valid, a TA for both the UCI and the SDT is valid, or any combination thereof. Comparatively, in cases where the UE 115-d is configured to transmit the UCI message via PUCCH resources, the UE 115-d may be configured to perform TA validation before each transmission of UCI, and/or may be configured to suspend TA validation (e.g., suspend TA validation within a time window configured by the network).

Techniques described herein may facilitate more efficient use of resources by enabling the UE 115-d to transmit UCI messages along with SDTs while in an inactive state and/or idle state in the context of a CG-SDT procedure. In particular, by enabling the UE 115-d to transmit UCI messages along with SDTs in an inactive or idle state, techniques described herein may enable the UE 115-d to transmit small amounts of control data prior to (or without) establishing a full wireless connection with the base station 105-d, which may reduce signaling overhead associated with establishing wireless connections between the UE 115-d and the network, and may reduce latency associated with UCI messages.

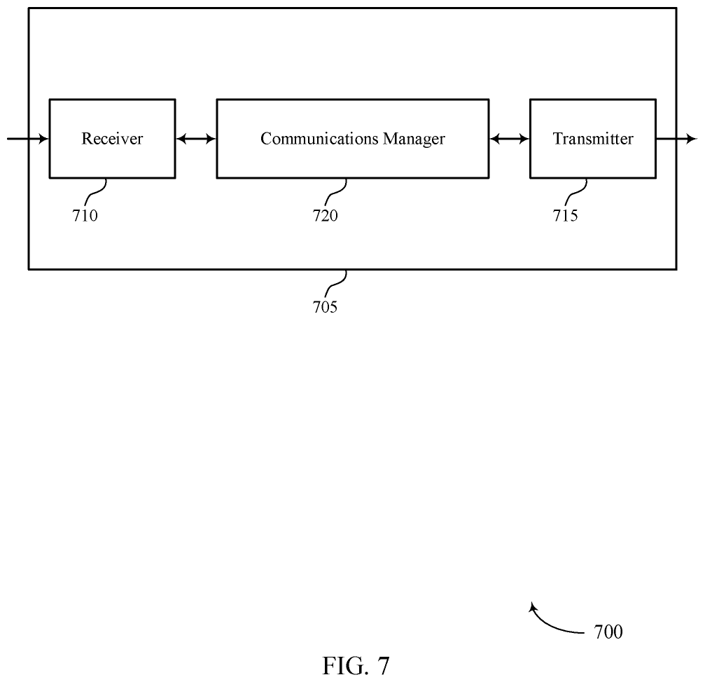

FIG. 7 shows a block diagram 700 of a device 705 that supports techniques for UCI transmission with small data transmission in accordance with aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the UCI transmission features discussed herein. Each of these components may be in communication with each other (e.g., via one or more buses).

The receiver 710 may provide a means for receiving information such as packets, user data, control information, or any combination thereof associated with various information channels (e.g., control channels, data channels, information channels related to techniques for UCI transmission with small data transmission). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for UCI transmission with small data transmission). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for UCI transmission with small data transmission as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

For example, the communications manager 720 may be configured as or otherwise support a means for receiving, from a base station, control signaling identifying a first set of resources for data transmissions and a second set of resources for UCI transmission by the UE when the UE is in an inactive state or an idle state. The communications manager 720 may be configured as or otherwise support a means for generating, when the UE is in one of the inactive state or the idle state, a UCI message based on the second set of resources. The communications manager 720 may be configured as or otherwise support a means for transmitting, to the base station when the UE in the one of the inactive state or the idle state, a data message on at least a portion of the first set of resources and the UCI message on the second set of resources.

By including or configuring the communications manager 720 in accordance with examples as described herein, the device 705 (e.g., a processor controlling or otherwise coupled to the receiver 710, the transmitter 715, the communications manager 720, or a combination thereof) may support techniques which may facilitate more efficient use of resources by enabling UEs 115 to transmit UCI messages along with SDTs while in an inactive state and/or idle state in the context of a CG-SDT procedure. In particular, by enabling UEs 115 to transmit UCI messages along with SDTs in an inactive or idle state, techniques described herein may enable UEs 115 to transmit small amounts of control data prior to (or without) establishing a full wireless connection with the base station 105, which may reduce signaling overhead associated with establishing wireless connections between the UEs 115 and the network, and may reduce latency associated with UCI messages.

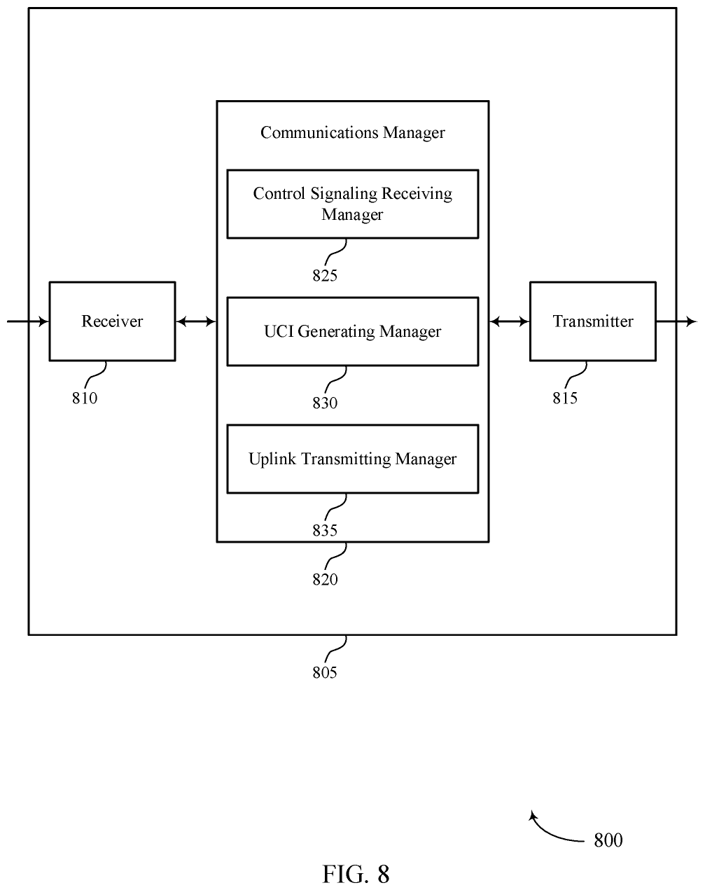

FIG. 8 shows a block diagram 800 of a device 805 that supports techniques for UCI transmission with small data transmission in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for UCI transmission with small data transmission). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for UCI transmission with small data transmission). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for UCI transmission with small data transmission as described herein. For example, the communications manager 820 may include a control signaling receiving manager 825, a UCI generating manager 830, an uplink transmitting manager 835, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The control signaling receiving manager 825 may be configured as or otherwise support a means for receiving, from a base station, control signaling identifying a first set of resources for data transmissions and a second set of resources for UCI transmission by the UE when the UE is in an inactive state or an idle state. The UCI generating manager 830 may be configured as or otherwise support a means for generating, when the UE is in one of the inactive state or the idle state, a UCI message based on the second set of resources. The uplink transmitting manager 835 may be configured as or otherwise support a means for transmitting, to the base station when the UE in the one of the inactive state or the idle state, a data message on at least a portion of the first set of resources and the UCI message on the second set of resources.

In some cases, the control signaling receiving manager 825, the UCI generating manager 830, and the uplink transmitting manager 835 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of control signaling receiving manager 825, the UCI generating manager 830, and the uplink transmitting manager 835 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

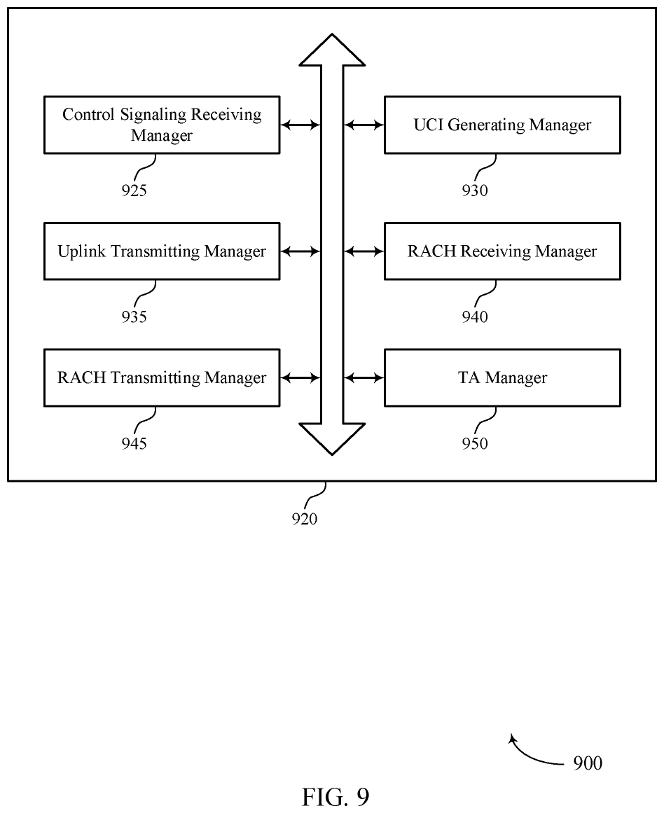

FIG. 9 shows a block diagram 900 of a communications manager 920 that supports techniques for UCI transmission with small data transmission in accordance with aspects of the present disclosure. The communications manager 920 may be an example of aspects of a communications manager 720, a communications manager 820, or both, as described herein. The communications manager 920, or various components thereof, may be an example of means for performing various aspects of techniques for UCI transmission with small data transmission as described herein. For example, the communications manager 920 may include a control signaling receiving manager 925, a UCI generating manager 930, an uplink transmitting manager 935, a RACH receiving manager 940, a RACH transmitting manager 945, a TA manager 950, or any combination thereof. Each of these components may communicate, directly or indirectly, with one another (e.g., via one or more buses).

The control signaling receiving manager 925 may be configured as or otherwise support a means for receiving, from a base station, control signaling identifying a first set of resources for data transmissions and a second set of resources for UCI transmission by the UE when the UE is in an inactive state or an idle state. The UCI generating manager 930 may be configured as or otherwise support a means for generating, when the UE is in one of the inactive state or the idle state, a UCI message based on the second set of resources. The uplink transmitting manager 935 may be configured as or otherwise support a means for transmitting, to the base station when the UE in the one of the inactive state or the idle state, a data message on at least a portion of the first set of resources and the UCI message on the second set of resources.

In some examples, to support receiving the control signaling, the RACH receiving manager 940 may be configured as or otherwise support a means for receiving, from the base station, a random access message of a random access procedure that identifies the first set of resources and the second set of resources.

In some examples, to support receiving the control signaling, the control signaling receiving manager 925 may be configured as or otherwise support a means for receiving, from the base station when the UE is in an active state, a message associated with releasing the UE from the active state to the inactive state or the idle state, where the message identifies the first set of resources and the second set of resources.

In some examples, to support transmitting the UCI message, the RACH transmitting manager 945 may be configured as or otherwise support a means for transmitting the UCI message on the second set of resources with a random access message of a random access procedure.

In some examples, the uplink transmitting manager 935 may be configured as or otherwise support a means for transmitting the UCI message with the random access message based on identifying that a TA for the UE is valid. In some examples, the uplink transmitting manager 935 may be configured as or otherwise support a means for transmitting the UCI message with the random access message after identifying that a TA for the UE is invalid. In some examples, receiving the control signaling when the UE is in an active state, the control signaling indicating a set of multiple transmission occasions for the data transmissions, the set of multiple transmission occasions including the first set of resources, where the data message and the UCI message are transmitted within a transmission occasion of the set of multiple transmission occasions.

In some examples, to support transmitting the data message and the UCI message, the uplink transmitting manager 935 may be configured as or otherwise support a means for multiplexing the data message and the UCI message within the transmission occasion. In some examples, to support transmitting the data message and the UCI message, the uplink transmitting manager 935 may be configured as or otherwise support a means for refraining from transmitting the data message within a first transmission occasion of the set of multiple transmission occasions based on generating the UCI message to be transmitted in the first transmission occasion. In some examples, to support transmitting the data message and the UCI message, the uplink transmitting manager 935 may be configured as or otherwise support a means for transmitting the UCI message within the first transmission occasion based on refraining from transmitting the data message. In some examples, to support transmitting the data message and the UCI message, the uplink transmitting manager 935 may be configured as or otherwise support a means for transmitting the data message within a second transmission occasion of the set of multiple transmission occasions based on transmitting the UCI message within the first transmission occasion.

In some examples, the control signaling receiving manager 925 may be configured as or otherwise support a means for receiving, via the control signaling, an indication for the UE to multiplex the UCI with the data message within the second set of resources which are included within the first set of resources, where transmitting the data message and the UCI message is based on the indication. In some examples, the second set of resources include a set of common uplink control resources, a set of dedicated uplink control resources, or any combination thereof. In some examples, the first set of resources include a set of uplink shared resources.

In some examples, the uplink transmitting manager 935 may be configured as or otherwise support a means for transmitting the UCI message based on identifying that a TA for the UE is valid.

In some examples, to support identifying that the TA for the UE is valid, the TA manager 950 may be configured as or otherwise support a means for identifying that a first TA for the UCI message is valid, that a second TA for the data message is valid, that a third TA for both the UCI message and the data message is valid, or any combination thereof.

In some examples, the control signaling receiving manager 925 may be configured as or otherwise support a means for receiving, via the control signaling, an indication of a suspension of TA validation at the UE, where transmitting the UCI message is at least in part in response to the suspension of TA validation. In some examples, the UCI message includes HARQ feedback responsive to a contention resolution message, a downlink control plane message, a downlink user plane message, an RRC release message, or any combination thereof. In some examples, the UCI message includes a first CSI report that is smaller than a second CSI report for an active state, a beam failure report, a BWP index, a coverage enhancement request, a request for a termination of a set of data messages including the data message, or any combination thereof.

In some cases, the control signaling receiving manager 925, the UCI generating manager 930, the uplink transmitting manager 935, the RACH receiving manager 940, the RACH transmitting manager 945, and the TA manager 950 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling receiving manager 925, the UCI generating manager 930, the uplink transmitting manager 935, the RACH receiving manager 940, the RACH transmitting manager 945, and the TA manager 950 discussed herein.

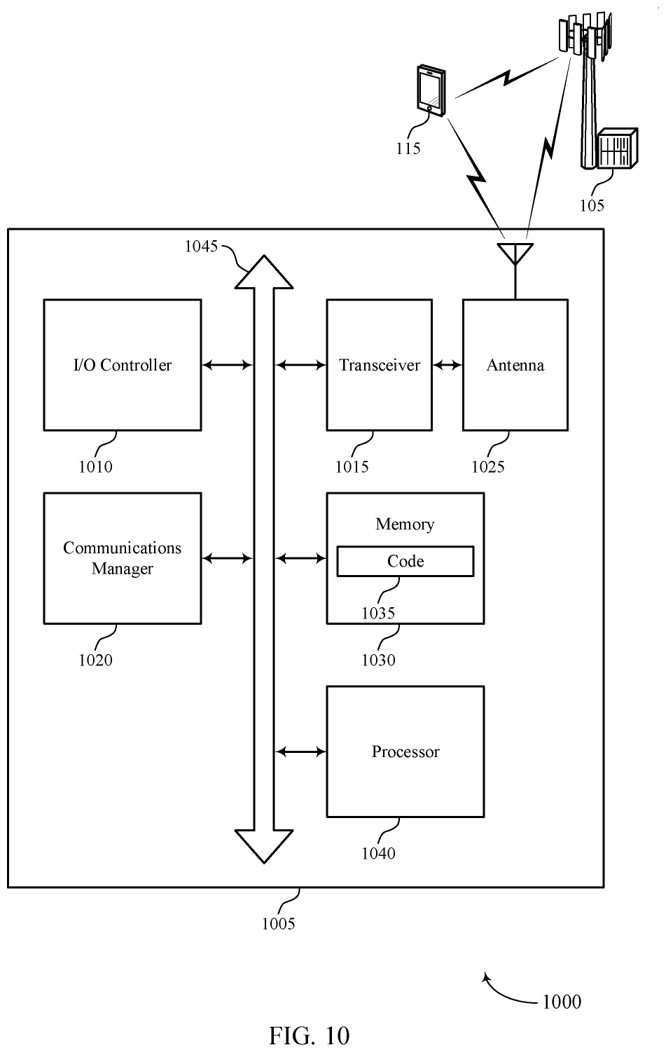

FIG. 10 shows a diagram of a system 1000 including a device 1005 that supports techniques for UCI transmission with small data transmission in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for UCI transmission with small data transmission). For example, the device 1005 or a component of the device 1005 may include a processor 1040 and memory 1030 coupled to the processor 1040, the processor 1040 and memory 1030 configured to perform various functions described herein.

For example, the communications manager 1020 may be configured as or otherwise support a means for receiving, from a base station, control signaling identifying a first set of resources for data transmissions and a second set of resources for UCI transmission by the UE when the UE is in an inactive state or an idle state. The communications manager 1020 may be configured as or otherwise support a means for generating, when the UE is in one of the inactive state or the idle state, a UCI message based on the second set of resources. The communications manager 1020 may be configured as or otherwise support a means for transmitting, to the base station when the UE in the one of the inactive state or the idle state, a data message on at least a portion of the first set of resources and the UCI message on the second set of resources.

By including or configuring the communications manager 1020 in accordance with examples as described herein, the device 1005 may support techniques which may facilitate more efficient use of resources by enabling UEs 115 to transmit UCI messages along with SDTs while in an inactive state and/or idle state in the context of a CG-SDT procedure. In particular, by enabling UEs 115 to transmit UCI messages along with SDTs in an inactive or idle state, techniques described herein may enable UEs 115 to transmit small amounts of control data prior to (or without) establishing a full wireless connection with the base station 105, which may reduce signaling overhead associated with establishing wireless connections between the UEs 115 and the network, and may reduce latency associated with UCI messages. Further, by preventing the need for UEs 115 to establish full wireless connections with the network to transmit small amounts of data, techniques described herein may reduce power consumption at the UEs 115, and improve battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for UCI transmission with small data transmission as described herein, or the processor 1040 and the memory 1030 may be otherwise configured to perform or support such operations.

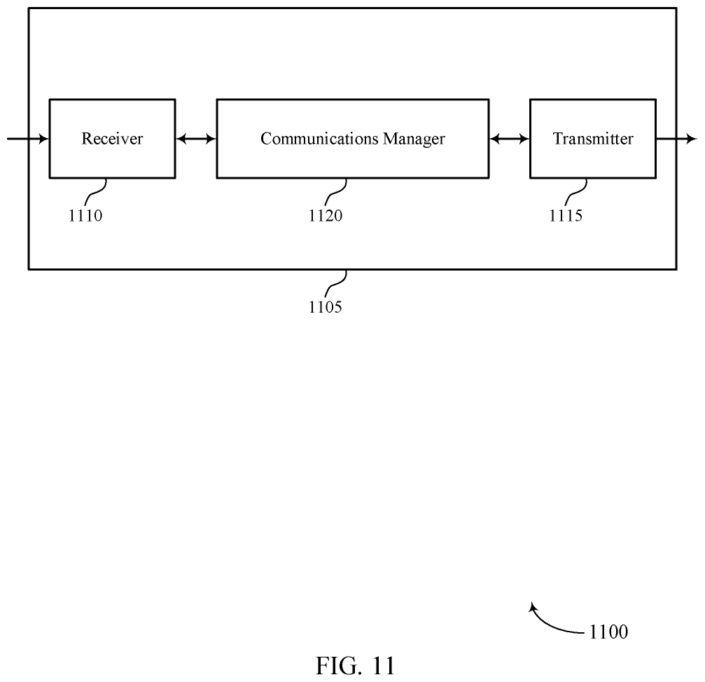

FIG. 11 shows a block diagram 1100 of a device 1105 that supports techniques for UCI transmission with small data transmission in accordance with aspects of the present disclosure. The device 1105 may be an example of aspects of a base station 105 as described herein. The device 1105 may include a receiver 1110, a transmitter 1115, and a communications manager 1120. The device 1105 may also include a one or more processors, memory coupled with the one or more processors, and instructions stored in the memory that are executable by the one or more processors to enable the one or more processors to perform the UCI transmission features discussed herein. Each of these components may be in communication with each other (e.g., via one or more buses).

The receiver 1110 may provide a means for receiving information such as packets, user data, control information, or any combination thereof associated with various information channels (e.g., control channels, data channels, information channels related to techniques for UCI transmission with small data transmission). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for UCI transmission with small data transmission). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of techniques for UCI transmission with small data transmission as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. For example, the communications manager 1120 may be configured as or otherwise support a means for transmitting, to a UE, control signaling identifying a first set of resources for data transmissions and a second set of resources for UCI transmission by the UE when the UE is in an inactive state or an idle state. The communications manager 1120 may be configured as or otherwise support a means for receiving, from the UE when the UE in the one of the inactive state or the idle state, a data message on at least a portion of the first set of resources and a UCI message on the second set of resources.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques which may facilitate more efficient use of resources by enabling UEs 115 to transmit UCI messages along with SDTs while in an inactive state and/or idle state in the context of a CG-SDT procedure. In particular, by enabling UEs 115 to transmit UCI messages along with SDTs in an inactive or idle state, techniques described herein may enable UEs 115 to transmit small amounts of control data prior to (or without) establishing a full wireless connection with the base station 105, which may reduce signaling overhead associated with establishing wireless connections between the UEs 115 and the network, and may reduce latency associated with UCI messages. Further, by preventing the need for UEs 115 to establish full wireless connections with the network to transmit small amounts of data, techniques described herein may reduce power consumption at the UEs 115, and improve battery life.

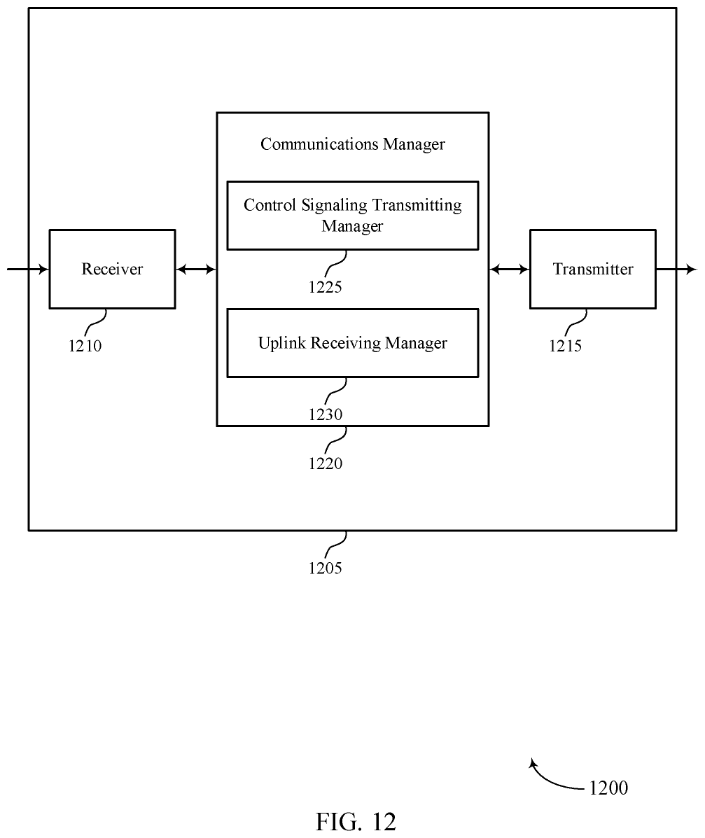

FIG. 12 shows a block diagram 1200 of a device 1205 that supports techniques for UCI transmission with small data transmission in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for UCI transmission with small data transmission). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for UCI transmission with small data transmission). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for UCI transmission with small data transmission as described herein. For example, the communications manager 1220 may include a control signaling transmitting manager 1225 an uplink receiving manager 1230, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. The control signaling transmitting manager 1225 may be configured as or otherwise support a means for transmitting, to a UE, control signaling identifying a first set of resources for data transmissions and a second set of resources for UCI transmission by the UE when the UE is in an inactive state or an idle state. The uplink receiving manager 1230 may be configured as or otherwise support a means for receiving, from the UE when the UE in the one of the inactive state or the idle state, a data message on at least a portion of the first set of resources and a UCI message on the second set of resources.

In some cases, the control signaling transmitting manager 1225 and the uplink receiving manager 1230 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling transmitting manager 1225 and the uplink receiving manager 1230 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

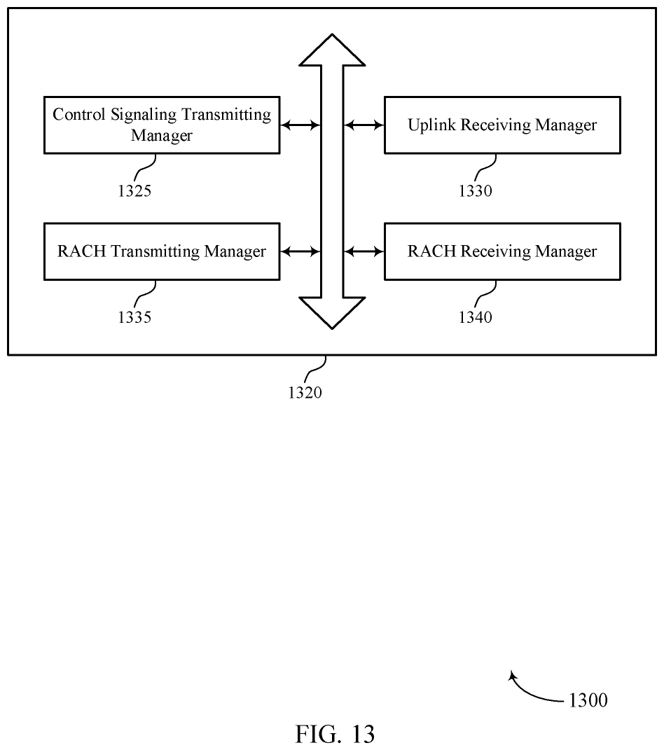

FIG. 13 shows a block diagram 1300 of a communications manager 1320 that supports techniques for UCI transmission with small data transmission in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of techniques for UCI transmission with small data transmission as described herein. For example, the communications manager 1320 may include a control signaling transmitting manager 1325, an uplink receiving manager 1330, a RACH transmitting manager 1335, a RACH receiving manager 1340, or any combination thereof. Each of these components may communicate, directly or indirectly, with one another (e.g., via one or more buses).

The communications manager 1320 may support wireless communication at a base station in accordance with examples as disclosed herein. The control signaling transmitting manager 1325 may be configured as or otherwise support a means for transmitting, to a UE, control signaling identifying a first set of resources for data transmissions and a second set of resources for UCI transmission by the UE when the UE is in an inactive state or an idle state. The uplink receiving manager 1330 may be configured as or otherwise support a means for receiving, from the UE when the UE in the one of the inactive state or the idle state, a data message on at least a portion of the first set of resources and a UCI message on the second set of resources.

In some examples, to support transmitting the control signaling, the RACH transmitting manager 1335 may be configured as or otherwise support a means for transmitting a random access message of a random access procedure that identifies the first set of resources and the second set of resources.

In some examples, to support transmitting the control signaling, the control signaling transmitting manager 1325 may be configured as or otherwise support a means for transmitting, to the UE when the UE is in an active state, a message associated with releasing the UE from the active state to the inactive state or the idle state, where the message identifies the first set of resources and the second set of resources.

In some examples, to support receiving the UCI message, the RACH receiving manager 1340 may be configured as or otherwise support a means for receiving the UCI message on the second set of resources with a random access message of a random access procedure.

In some examples, the control signaling transmitting manager 1325 may be configured as or otherwise support a means for transmitting, via the control signaling, an indication for the UE to multiplex the UCI with the data message within the second set of resources which are included within the first set of resources, where receiving the data message and the UCI message is at least in part in response to transmitting the indication. In some examples, the second set of resources include a set of common uplink control resources, a set of dedicated uplink control resources, or any combination thereof. In some examples, the first set of resources include a set of uplink shared resources.

In some examples, the control signaling transmitting manager 1325 may be configured as or otherwise support a means for transmitting, via the control signaling, an indication of a suspension of TA validation at the UE, where receiving the UCI message is at least in part in response to the suspension of TA validation. In some examples, the UCI message includes HARQ feedback responsive to a contention resolution message, a downlink control plane message, a downlink user plane message, an RRC release message, or any combination thereof. In some examples, the UCI message includes a first CSI report that is smaller than a second CSI report for an active state, a beam failure report, a BWP index, a coverage enhancement request, a request for a termination of a set of data messages including the data message, or any combination thereof.

In some cases, the control signaling transmitting manager 1325, the uplink receiving manager 1330, the RACH transmitting manager 1335, and the RACH receiving manager 1340 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signaling transmitting manager 1325, the uplink receiving manager 1330, the RACH transmitting manager 1335, and the RACH receiving manager 1340 discussed herein.

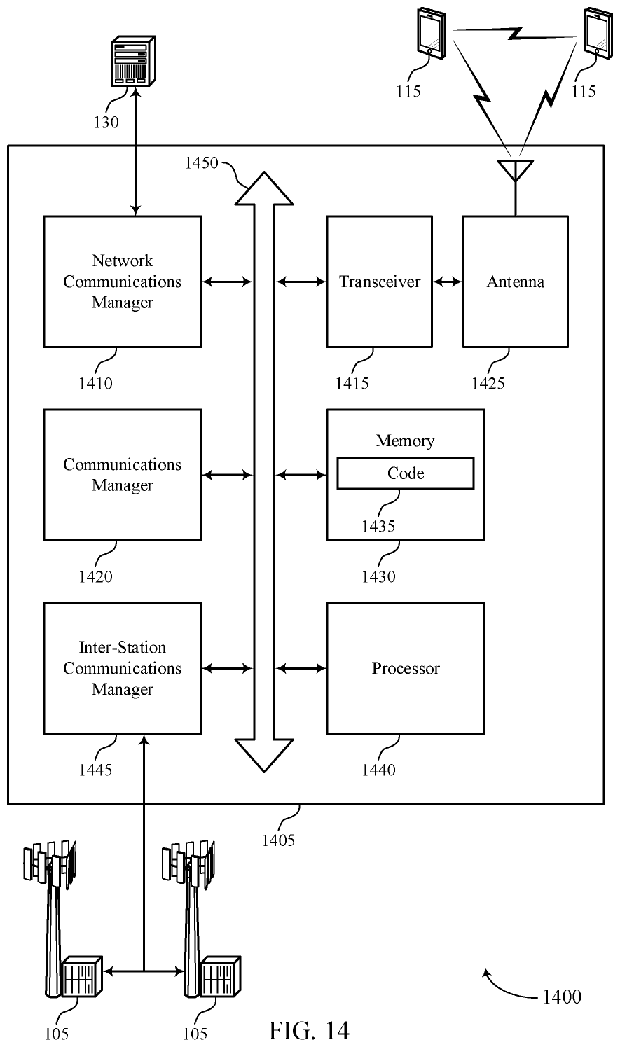

FIG. 14 shows a diagram of a system 1400 including a device 1405 that supports techniques for UCI transmission with small data transmission in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting techniques for UCI transmission with small data transmission). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a base station in accordance with examples as disclosed herein. For example, the communications manager 1420 may be configured as or otherwise support a means for transmitting, to a UE, control signaling identifying a first set of resources for data transmissions and a second set of resources for UCI transmission by the UE when the UE is in an inactive state or an idle state. The communications manager 1420 may be configured as or otherwise support a means for receiving, from the UE when the UE in the one of the inactive state or the idle state, a data message on at least a portion of the first set of resources and a UCI message on the second set of resources.

By including or configuring the communications manager 1420 in accordance with examples as described herein, the device 1405 may support techniques which may facilitate more efficient use of resources by enabling UEs 115 to transmit UCI messages along with SDTs while in an inactive state and/or idle state in the context of a CG-SDT procedure. In particular, by enabling UEs 115 to transmit UCI messages along with SDTs in an inactive or idle state, techniques described herein may enable UEs 115 to transmit small amounts of control data prior to (or without) establishing a full wireless connection with the base station 105, which may reduce signaling overhead associated with establishing wireless connections between the UEs 115 and the network, and may reduce latency associated with UCI messages.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of techniques for UCI transmission with small data transmission as described herein, or the processor 1440 and the memory 1430 may be otherwise configured to perform or support such operations.

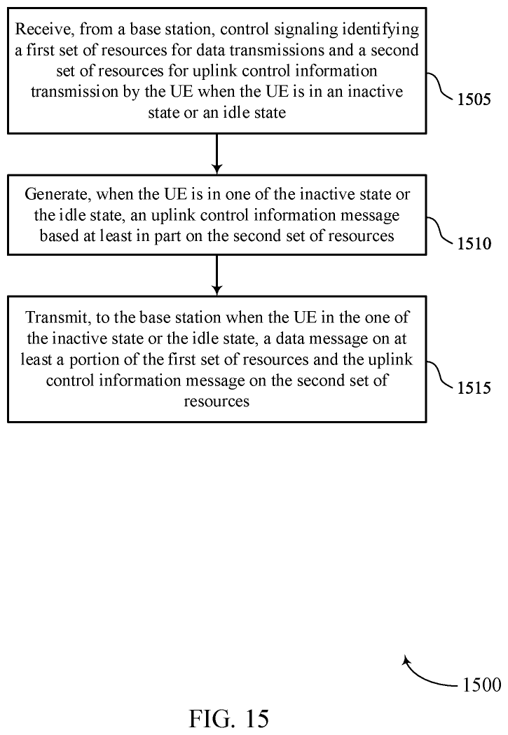

FIG. 15 shows a flowchart illustrating a method 1500 that supports techniques for UCI transmission with small data transmission in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, control signaling identifying a first set of resources for data transmissions and a second set of resources for UCI transmission by the UE when the UE is in an inactive state or an idle state. The operations of 1505 may be performed in accordance with examples as disclosed herein. In some examples, aspects of the operations of 1505 may be performed by a control signaling receiving manager 925 as described with reference to FIG. 9.

At 1510, the method may include generating, when the UE is in one of the inactive state or the idle state, a UCI message based on the second set of resources. The operations of 1510 may be performed in accordance with examples as disclosed herein. In some examples, aspects of the operations of 1510 may be performed by a UCI generating manager 930 as described with reference to FIG. 9.

At 1515, the method may include transmitting, to the base station when the UE in the one of the inactive state or the idle state, a data message on at least a portion of the first set of resources and the UCI message on the second set of resources. The operations of 1515 may be performed in accordance with examples as disclosed herein. In some examples, aspects of the operations of 1515 may be performed by an uplink transmitting manager 935 as described with reference to FIG. 9.

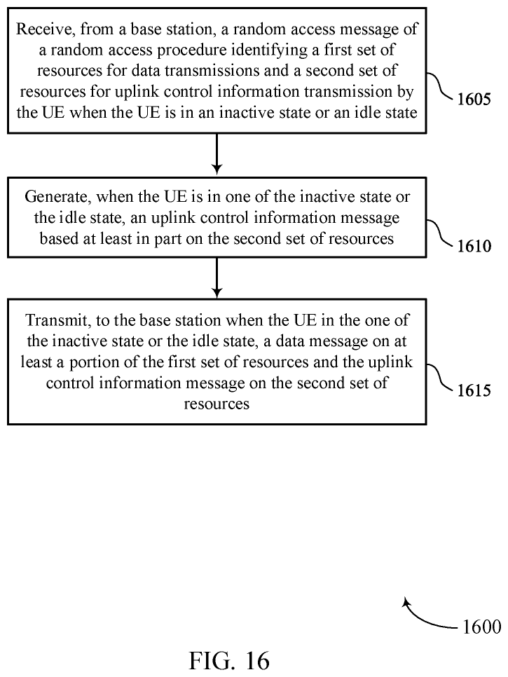

FIG. 16 shows a flowchart illustrating a method 1600 that supports techniques for UCI transmission with small data transmission in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, a random access message of a random access procedure identifying a first set of resources for data transmissions and a second set of resources for UCI transmission by the UE when the UE is in an inactive state or an idle state. The operations of 1605 may be performed in accordance with examples as disclosed herein. In some examples, aspects of the operations of 1605 may be performed by a control signaling receiving manager 925 as described with reference to FIG. 9.

At 1610, the method may include generating, when the UE is in one of the inactive state or the idle state, a UCI message based on the second set of resources. The operations of 1610 may be performed in accordance with examples as disclosed herein. In some examples, aspects of the operations of 1610 may be performed by a UCI generating manager 930 as described with reference to FIG. 9.

At 1615, the method may include transmitting, to the base station when the UE in the one of the inactive state or the idle state, a data message on at least a portion of the first set of resources and the UCI message on the second set of resources. The operations of 1615 may be performed in accordance with examples as disclosed herein. In some examples, aspects of the operations of 1615 may be performed by an uplink transmitting manager 935 as described with reference to FIG. 9.

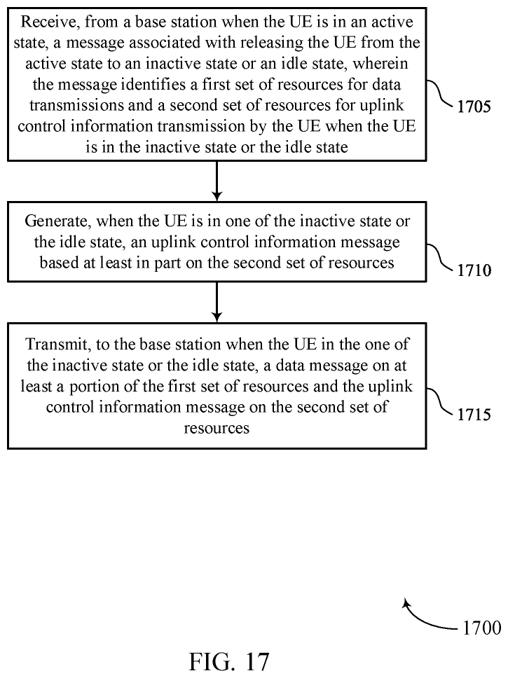

FIG. 17 shows a flowchart illustrating a method 1700 that supports techniques for UCI transmission with small data transmission in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include receiving, from a base station while the UE is in an active state, a message associated with releasing the UE from the active state to an inactive state or an idle state, wherein the message identifies a first set of resources for data transmissions and a second set of resources for UCI transmission by the UE when the UE is in the inactive state or the idle state. The operations of 1705 may be performed in accordance with examples as disclosed herein. In some examples, aspects of the operations of 1705 may be performed by a control signaling receiving manager 925 as described with reference to FIG. 9.

At 1710, the method may include generating, when the UE is in one of the inactive state or the idle state, a UCI message based on the second set of resources. The operations of 1710 may be performed in accordance with examples as disclosed herein. In some examples, aspects of the operations of 1710 may be performed by a UCI generating manager 930 as described with reference to FIG. 9.

At 1720, the method may include transmitting, to the base station when the UE in the one of the inactive state or the idle state, a data message on at least a portion of the first set of resources and the UCI message on the second set of resources. The operations of 1720 may be performed in accordance with examples as disclosed herein. In some examples, aspects of the operations of 1720 may be performed by an uplink transmitting manager 935 as described with reference to FIG. 9.

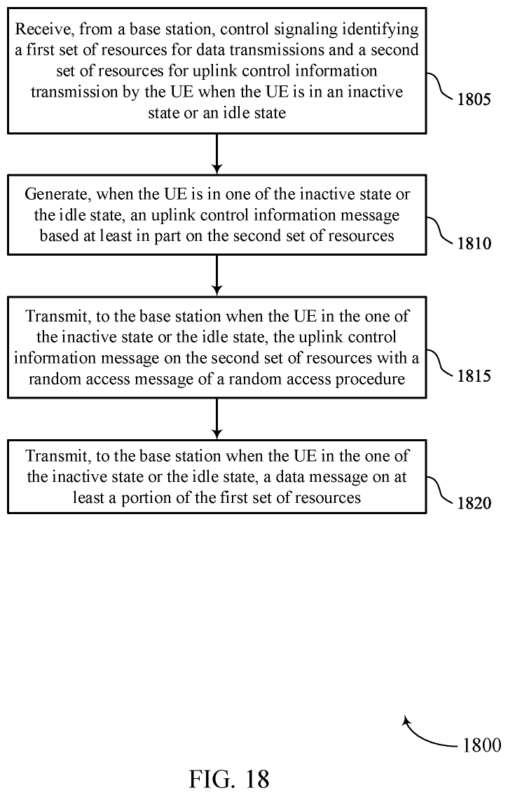

FIG. 18 shows a flowchart illustrating a method 1800 that supports techniques for UCI transmission with small data transmission in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1805, the method may include receiving, from a base station, control signaling identifying a first set of resources for data transmissions and a second set of resources for UCI transmission by the UE when the UE is in an inactive state or an idle state. The operations of 1805 may be performed in accordance with examples as disclosed herein. In some examples, aspects of the operations of 1805 may be performed by a control signaling receiving manager 925 as described with reference to FIG. 9.

At 1810, the method may include generating, when the UE is in one of the inactive state or the idle state, a UCI message based on the second set of resources. The operations of 1810 may be performed in accordance with examples as disclosed herein. In some examples, aspects of the operations of 1810 may be performed by a UCI generating manager 930 as described with reference to FIG. 9.

At 1815, the method may include transmitting, to the base station when the UE in the one of the inactive state or the idle state, the UCI message on the second set of resources with a random access message of a random access procedure. The operations of 1815 may be performed in accordance with examples as disclosed herein. In some examples, aspects of the operations of 1815 may be performed by a RACH transmitting manager 945 as described with reference to FIG. 9.

At 1820, the method may include transmitting, to the base station when the UE in the one of the inactive state or the idle state, a data message on at least a portion of the first set of resources. The operations of 1820 may be performed in accordance with examples as disclosed herein. In some examples, aspects of the operations of 1820 may be performed by an uplink transmitting manager 935 as described with reference to FIG. 9.

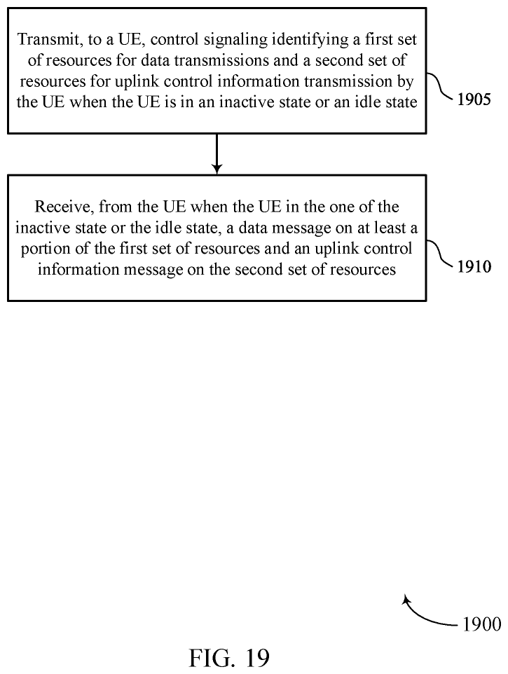

FIG. 19 shows a flowchart illustrating a method 1900 that supports techniques for UCI transmission with small data transmission in accordance with aspects of the present disclosure. The operations of the method 1900 may be implemented by a base station or its components as described herein. For example, the operations of the method 1900 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1905, the method may include transmitting, to a UE, control signaling identifying a first set of resources for data transmissions and a second set of resources for UCI transmission by the UE when the UE is in an inactive state or an idle state. The operations of 1905 may be performed in accordance with examples as disclosed herein. In some examples, aspects of the operations of 1905 may be performed by a control signaling transmitting manager 1325 as described with reference to FIG. 13.

At 1910, the method may include receiving, from the UE when the UE in the one of the inactive state or the idle state, a data message on at least a portion of the first set of resources and a UCI message on the second set of resources. The operations of 1910 may be performed in accordance with examples as disclosed herein. In some examples, aspects of the operations of 1910 may be performed by an uplink receiving manager 1330 as described with reference to FIG. 13.

The following provides an overview of aspects of the present disclosure:

Aspect 1: A method for wireless communication at a UE, comprising: receiving, from a base station, control signaling identifying a first set of resources for data transmissions and a second set of resources for UCI transmission by the UE when the UE is in an inactive state or an idle state; generating, when the UE is in one of the inactive state or the idle state, a UCI message based at least in part on the second set of resources; and transmitting, to the base station when the UE in the one of the inactive state or the idle state, a data message on at least a portion of the first set of resources and the UCI message on the second set of resources.

Aspect 2: The method of aspect 1, wherein receiving the control signaling comprises: receiving, from the base station, a random access message of a random access procedure that identifies the first set of resources and the second set of resources.

Aspect 3: The method of any of aspects 1 through 2, wherein receiving the control signaling comprises: receiving, from the base station when the UE is in an active state, a message associated with releasing the UE from the active state to the inactive state or the idle state, wherein the message identifies the first set of resources and the second set of resources.

Aspect 4: The method of any of aspects 1 through 3, wherein transmitting the UCI message comprises: transmitting the UCI message on the second set of resources with a random access message of a random access procedure.

Aspect 5: The method of aspect 4, wherein the random access procedure comprises a four-step random access procedure, the method further comprising: transmitting the UCI message with the random access message based at least in part on identifying that a TA for the UE is valid.

Aspect 6: The method of any of aspects 4 through 5, wherein the random access procedure comprises a two-step random access procedure, the method further comprising: transmitting the UCI message with the random access message after identifying that a TA for the UE is invalid.

Aspect 7: The method of any of aspects 1 through 6, wherein receiving the control signaling identifying the first set of resources for the data transmissions comprise receiving the control signaling when the UE is in an active state, the control signaling indicating a plurality of transmission occasions for the data transmissions, the plurality of transmission occasions comprising the first set of resources, wherein the data message and the UCI message are transmitted within a transmission occasion of the plurality of transmission occasions.

Aspect 8: The method of aspect 7, wherein transmitting the data message and the UCI message comprises: multiplexing the data message and the UCI message within the transmission occasion.

Aspect 9: The method of any of aspects 7 through 8, wherein transmitting the data message and the UCI message comprises: refraining from transmitting the data message within a first transmission occasion of the plurality of transmission occasions based at least in part on generating the UCI message to be transmitted in the first transmission occasion; transmitting the UCI message within the first transmission occasion based at least in part on refraining from transmitting the data message; and transmitting the data message within a second transmission occasion of the plurality of transmission occasions based at least in part on transmitting the UCI message within the first transmission occasion.

Aspect 10: The method of any of aspects 1 through 9, further comprising: receiving, via the control signaling, an indication for the UE to multiplex the UCI with the data message within the second set of resources which are included within the first set of resources, wherein transmitting the data message and the UCI message is based at least in part on the indication.

Aspect 11: The method of any of aspects 1 through 10, wherein the second set of resources comprise a set of common uplink control resources, a set of dedicated uplink control resources, or any combination thereof, and the first set of resources comprise a set of uplink shared resources.

Aspect 12: The method of any of aspects 1 through 11, further comprising: transmitting the UCI message based at least in part on identifying that a TA for the UE is valid.

Aspect 13: The method of aspect 12, wherein identifying that the TA for the UE is valid comprises: identifying that a first TA for the UCI message is valid, that a second TA for the data message is valid, that a third TA for both the UCI message and the data message is valid, or any combination thereof.

Aspect 14: The method of any of aspects 1 through 13, further comprising: receiving, via the control signaling, an indication of a suspension of TA validation at the UE, wherein transmitting the UCI message is at least in part in response to the suspension of TA validation.

Aspect 15: The method of any of aspects 1 through 14, wherein the UCI message comprises HARQ feedback responsive to a contention resolution message, a downlink control plane message, a downlink user plane message, an RRC release message, or any combination thereof.

Aspect 16: The method of any of aspects 1 through 15, wherein the UCI message comprises a first CSI report that is smaller than a second CSI report for an active state, a beam failure report, a BWP index, a coverage enhancement request, a request for a termination of a set of data messages including the data message, or any combination thereof.

Aspect 17: The method of any of aspects 1 through 16, further comprising: receiving, from the base station, a control message indicating one or more parameters associated with the UCI message, the one or more parameters comprising a resource index, a transmit beam index, a quantity of repetitions, a frequency hopping scheme, an OCC, or any combination thereof, wherein the control message comprises a downlink control information message, a medium access control-control element message, an RRC message, a system information message, or any combination thereof.

Aspect 18: A method for wireless communication at a base station, comprising: transmitting, to a UE, control signaling identifying a first set of resources for data transmissions and a second set of resources for UCI transmission by the UE when the UE is in an inactive state or an idle state; and receiving, from the UE when the UE in the one of the inactive state or the idle state, a data message on at least a portion of the first set of resources and a UCI message on the second set of resources.

Aspect 19: The method of aspect 18, wherein transmitting the control signaling comprises: transmitting a random access message of a random access procedure that identifies the first set of resources and the second set of resources.

Aspect 20: The method of any of aspects 18 through 19, wherein transmitting the control signaling comprises: transmitting, to the UE when the UE is in an active state, a message associated with releasing the UE from the active state to the inactive state or the idle state, wherein the message identifies the first set of resources and the second set of resources.

Aspect 21: The method of any of aspects 18 through 20, wherein receiving the UCI message comprises: receiving the UCI message on the second set of resources with a random access message of a random access procedure.

Aspect 22: The method of any of aspects 18 through 21, further comprising:

transmitting, via the control signaling, an indication for the UE to multiplex the UCI with the data message within the second set of resources which are included within the first set of resources, wherein receiving the data message and the UCI message is at least in part in response to transmitting the indication.

Aspect 23: The method of any of aspects 18 through 22, wherein the second set of resources comprise a set of common uplink control resources, a set of dedicated uplink control resources, or any combination thereof, and the first set of resources comprise a set of uplink shared resources.

Aspect 24: The method of any of aspects 18 through 23, further comprising: transmitting, via the control signaling, an indication of a suspension of TA validation at the UE, wherein receiving the UCI message is at least in part in response to the suspension of TA validation.

Aspect 25: The method of any of aspects 18 through 24, wherein the UCI message comprises HARQ feedback responsive to a contention resolution message, a downlink control plane message, a downlink user plane message, an RRC release message, or any combination thereof.

Aspect 26: The method of any of aspects 18 through 25, wherein the UCI message comprises a first CSI report that is smaller than a second CSI report for an active state, a beam failure report, a BWP index, a coverage enhancement request, a request for a termination of a set of data messages including the data message, or any combination thereof.

Aspect 27: The method of any of aspects 18 through 26, further comprising: transmitting, to the UE, a control message indicating one or more parameters associated with the UCI message, the one or more parameters comprising a resource index, a transmit beam index, a quantity of repetitions, a frequency hopping scheme, an OCC, or any combination thereof, wherein the control message comprises a downlink control information message, a medium access control-control element message, an RRC message, a system information message, or any combination thereof.

Aspect 28: An apparatus comprising a processor; memory coupled with the processor; and instructions stored in the memory and executable by the processor to cause the apparatus to perform a method of any of aspects 1 through 17.

Aspect 29: An apparatus comprising at least one means for performing a method of any of aspects 1 through 17.

Aspect 30: A non-transitory computer-readable medium storing code the code comprising instructions executable by a processor to perform a method of any of aspects 1 through 17.

Aspect 31: An apparatus for wireless communication at a base station, comprising a processor; memory coupled with the processor; and instructions stored in the memory and executable by the processor to cause the apparatus to perform a method of any of aspects 18 through 27.

Aspect 32: An apparatus for wireless communication at a base station, comprising at least one means for performing a method of any of aspects 18 through 27.

Aspect 33: A non-transitory computer-readable medium storing code for wireless communication at a base station, the code comprising instructions executable by a processor to perform a method of any of aspects 18 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control signaling identifying a first set of resources for data transmissions and a second set of resources for uplink control information transmission by the UE when the UE is in an inactive state or an idle state;
generating, when the UE is in one of the inactive state or the idle state, an uplink control information message based at least in part on the second set of resources; and
transmitting, to the base station when the UE in the one of the inactive state or the idle state, a data message on at least a portion of the first set of resources and the uplink control information message on the second set of resources.

2. The method of claim 1, wherein receiving the control signaling comprises:
receiving, from the base station, a random access message of a random access procedure that identifies the first set of resources and the second set of resources.

3. The method of claim 1, wherein receiving the control signaling comprises:
receiving, from the base station when the UE is in an active state, a message associated with releasing the UE from the active state to the inactive state or the idle state, wherein the message identifies the first set of resources and the second set of resources.

4. The method of claim 1, wherein transmitting the uplink control information message comprises:
transmitting the uplink control information message on the second set of resources with a random access message of a random access procedure.

5. The method of claim 4, wherein the random access procedure comprises a four-step random access procedure, the method further comprising:
transmitting the uplink control information message with the random access message based at least in part on identifying that a timing advance for the UE is valid.

6. The method of claim 4, wherein the random access procedure comprises a two-step random access procedure, the method further comprising:
transmitting the uplink control information message with the random access message after identifying that a timing advance for the UE is invalid.

7. The method of claim 1, wherein receiving the control signaling identifying the first set of resources for the data transmissions comprise receiving the control signaling when the UE is in an active state, the control signaling indicating a plurality of transmission occasions for the data transmissions, the plurality of transmission occasions comprising the first set of resources, wherein the data message and the uplink control information message are transmitted within a transmission occasion of the plurality of transmission occasions.

8. The method of claim 7, wherein transmitting the data message and the uplink control information message comprises:
multiplexing the data message and the uplink control information message within the transmission occasion.

9. The method of claim 7, wherein transmitting the data message and the uplink control information message comprises:
refraining from transmitting the data message within a first transmission occasion of the plurality of transmission occasions based at least in part on generating the uplink control information message to be transmitted in the first transmission occasion;
transmitting the uplink control information message within the first transmission occasion based at least in part on refraining from transmitting the data message; and
transmitting the data message within a second transmission occasion of the plurality of transmission occasions based at least in part on transmitting the uplink control information message within the first transmission occasion.

10. The method of claim 1, further comprising:
receiving, via the control signaling, an indication for the UE to multiplex the uplink control information with the data message within the second set of resources which are included within the first set of resources, wherein transmitting the data message and the uplink control information message is based at least in part on the indication.

11. The method of claim 1, wherein the second set of resources comprise a set of common uplink control resources, a set of dedicated uplink control resources, or any combination thereof, and wherein the first set of resources comprise a set of uplink shared resources.

12. The method of claim 1, further comprising:
transmitting the uplink control information message based at least in part on identifying that a timing advance for the UE is valid.

13. The method of claim 12, wherein identifying that the timing advance for the UE is valid comprises:
identifying that a first timing advance for the uplink control information message is valid, that a second timing advance for the data message is valid, that a third timing advance for both the uplink control information message and the data message is valid, or any combination thereof.

14. The method of claim 1, further comprising:
receiving, via the control signaling, an indication of a suspension of timing advance validation at the UE, wherein transmitting the uplink control information message is at least in part in response to the suspension of timing advance validation.

15. The method of claim 1, wherein the uplink control information message comprises hybrid automatic repeat request feedback responsive to a contention resolution message, a downlink control plane message, a downlink user plane message, a radio resource control release message, or any combination thereof.

16. The method of claim 1, wherein the uplink control information message comprises a first channel state information report that is smaller than a second channel state information report for an active state, a beam failure report, a bandwidth part index, a coverage enhancement request, a request for a termination of a set of data messages including the data message, or any combination thereof.

17. The method of claim 1, further comprising:
receiving, from the base station, a control message indicating one or more parameters associated with the uplink control information message, the one or more parameters comprising a resource index, a transmit beam index, a quantity of repetitions, a frequency hopping scheme, an orthogonal cover code, or any combination thereof, wherein the control message comprises a downlink control information message, a medium access control-control element message, a radio resource control message, a system information message, or any combination thereof.

18. A method for wireless communication at a base station, comprising:
transmitting, to a user equipment (UE), control signaling identifying a first set of resources for data transmissions and a second set of resources for uplink control information transmission by the UE when the UE is in an inactive state or an idle state; and
receiving, from the UE when the UE in the one of the inactive state or the idle state, a data message on at least a portion of the first set of resources and an uplink control information message on the second set of resources.

19. The method of claim 18, wherein transmitting the control signaling comprises:
transmitting a random access message of a random access procedure that identifies the first set of resources and the second set of resources.

20. The method of claim 18, wherein transmitting the control signaling comprises:
transmitting, to the UE when the UE is in an active state, a message associated with releasing the UE from the active state to the inactive state or the idle state, wherein the message identifies the first set of resources and the second set of resources.

21. The method of claim 18, wherein receiving the uplink control information message comprises:
receiving the uplink control information message on the second set of resources with a random access message of a random access procedure.

22. The method of claim 18, further comprising:
transmitting, via the control signaling, an indication for the UE to multiplex the uplink control information with the data message within the second set of resources which are included within the first set of resources, wherein receiving the data message and the uplink control information message is at least in part in response to transmitting the indication.

23. The method of claim 18, wherein the second set of resources comprise a set of common uplink control resources, a set of dedicated uplink control resources, or any combination thereof, and wherein the first set of resources comprise a set of uplink shared resources.

24. The method of claim 18, further comprising:
transmitting, via the control signaling, an indication of a suspension of timing advance validation at the UE, wherein receiving the uplink control information message is at least in part in response to the suspension of timing advance validation.

25. The method of claim 18, wherein the uplink control information message comprises hybrid automatic repeat request feedback responsive to a contention resolution message, a downlink control plane message, a downlink user plane message, a radio resource control release message, or any combination thereof.

26. The method of claim 18, wherein the uplink control information message comprises a first channel state information report that is smaller than a second channel state information report for an active state, a beam failure report, a bandwidth part index, a coverage enhancement request, a request for a termination of a set of data messages including the data message, or any combination thereof.

27. An apparatus, comprising:
a processor;
memory coupled with the processor; and
instructions stored in the memory and executable by the processor to cause the apparatus to:
receive, from a base station, control signaling identifying a first set of resources for data transmissions and a second set of resources for uplink control information transmission by the UE when the UE is in an inactive state or an idle state;
generate, when the UE is in one of the inactive state or the idle state, an uplink control information message based at least in part on the second set of resources; and
transmit, to the base station when the UE in the one of the inactive state or the idle state, a data message on at least a portion of the first set of resources and the uplink control information message on the second set of resources.

28. The apparatus of claim 27, wherein the instructions are further executable by the processor to receive the control signaling by being executable by the processor to cause the apparatus to:
receive, from the base station, a random access message of a random access procedure that identifies the first set of resources and the second set of resources.

29. The apparatus of claim 27, wherein the instructions are further executable by the processor to receive the control signaling by being executable by the processor to cause the apparatus to:
receive, from the base station when the UE is in an active state, a message associated with releasing the UE from the active state to the inactive state or the idle state, wherein the message identifies the first set of resources and the second set of resources.

30. An apparatus for wireless communication at a base station, comprising:
a processor;
memory coupled with the processor; and
instructions stored in the memory and executable by the processor to cause the apparatus to:
transmit, to a user equipment (UE), control signaling identifying a first set of resources for data transmissions and a second set of resources for uplink control information transmission by the UE when the UE is in an inactive state or an idle state; and
receive, from the UE when the UE in the one of the inactive state or the idle state, a data message on at least a portion of the first set of resources and an uplink control information message on the second set of resources.
